(19) United States
(12) Patent Application Publication
(10) Pub. No.: US 2004/0260020 A1
(43) Pub. Date: Dec. 23, 2004

(54) Modified polyvinyl acetal resin

(76) Inventors: Yoshitaka Miyake, Shiga (JP); Masakazu Sawada, Shiga (JP)

Correspondence Address: SUGHRUE MION, PLLC, 2100 PENNSYLVANIA AVENUE, N.W., SUITE 800, WASHINGTON, DC, 20037, US

(21) Appl. No.: 10/490,037

(22) PCT Filed: Sep. 20, 2002
(86) PCT No.: PCT/JP02/09669

(30) Foreign Application Priority Data
Sep. 21, 2001 (JP) 2001-289367
Sep. 21, 2001 (JP) 2001-289368

(51) Int. Cl. C08F 8/00

(52) U.S. Cl. 525/61

(57) ABSTRACT

It is an object of the present invention to provide a modified polyvinyl acetal resin, which is superior in flexibility, an adhesive property to a resin substrate under high humidities, heat resistance, a thermal decomposition property, humidity resistance and toughness and has low oxygen permeability and an adequate adhesive property and is low in viscosity and high in secular stability of viscosity in forming a solution thereof, and an adhesive composition, an ink, a coating material composition, a thermal developing photosensitive material, a slurry composition for a ceramic green sheet, and a ceramic green sheet, which use the modified polyvinyl acetal resin.

The present invention is a modified polyvinyl acetal resin, which is obtainable by acetalizing a modified polyvinyl alcohol having ethylene in a random basis as a constituent unit of a main chain and an ethylene content of 1 to 20 mole % and a saponification degree of 80 mole % or more and, has ethylene in a random basis as a constituent unit of a main chain.

### TECHNICAL FIELD

The present invention relates to a modified polyvinyl acetal resin, which is superior in flexibility, an adhesive property to a resin substrate under high humidities, heat resistance, a thermal decomposition property, humidity resistance and toughness and, has low oxygen permeability and an adequate adhesive property and is low in viscosity and high in secular stability of viscosity in forming a solution thereof, and an adhesive composition, an ink, a coating material composition, a thermal developing photosensitive material, a slurry composition for a ceramic green sheet, and a ceramic green sheet, which use the modified polyvinyl acetal resin.

### BACKGROUND ART

Conventionally, polyvinyl acetal resins such as a polyvinyl butyral resin have been used in various applications such as ink, coating materials, baking enamels, wash primers, lacquers, dispersants, adhesives, ceramic green sheets, thermal developing photosensitive materials, binders of water-based ink acceptance layers, etc. since they have high toughness, a high film forming property, high dispersibility of organic/inorganic powder of pigment or the like, and high adhesion to the surface to be coated.

The primary reason why the polyvinyl acetal resin is used in various applications like this is that a hydroxyl group exists in a polyvinyl acetal resin and therefore the polyvinyl acetal resin has toughness by virtue of a hydrogen bond of the hydroxyl group, but nevertheless the polyvinyl acetal resin becomes low in flexibility to some extent due to the hydrogen bond.

On the other hand, for example in Japanese Kokai Publication Hei-6-263521, there is disclosed an technique of realizing internal plasticization of a polyvinyl acetal resin by introducing a unit having a glycolic structure with a long chain into a side chain of the polyvinyl acetal resin. However, the flexibility of the polyvinyl acetal resin was improved by the introduction of a long chain, but there has been a problem that the solution viscosity of the resin in being dissolved in a solvent became high or a storage stability in a solution was poor and the viscosity thereof increased with the passage of time.

And, particularly in recent years, the frequency of uses of polyvinyl acetal resins, which does not use toluene, xylene or the like of an aromatic solvent and has high solubility in an alcoholic single solvent such as ethanol, propanol, has increased from the viewpoint of environmental protection. In terms of environmental protection, there are three major tendencies of higher solid contents, increase in water-based substance and adoption of powder matter as seen in the regulations of VOC in automobiles. Particularly, higher solid contents does not require a capital investment compared with another two tendencies and it has a feature that the performances can be guessed from the conventional articles and assured since it only reduces an amount of solvents to be used and increase the solid content, and therefore this technique are addressed by many researchers. As a method of realizing the higher solid contents using a polyvinyl acetal resin, it is conceivable to increase the concentration of a solid content, that is, to increase the content of a binder, but when the concentration of a solid content is increased, there are problems usually that the solution viscosity increase and the secular stability of solution viscosity is deteriorate.

With respect to these problems, as a method of lowering the viscosity of the solution, there are given methods of lowering a polymerization degree, modifying a molecular structure or the like and a printing ink and a coating material, which contain polyvinyl butyral resin using polyvinyl alcohol having a saponification degree of 70 to 96 mole % as a raw material, are disclosed in Japanese Kokai Publication Hei-11-349889. However, this solution containing the polyvinyl butyral resin had lower viscosity but was not sufficient in secular stability of viscosity and in flexibility in the case of being used in films, and there was not description on adhesion to a substrate and another performances such as humidity resistance although there was a description that lower viscosity and higher solid contents could be realized by suppressing an amount of residual acetyl groups.

As one of uses of a polyvinyl acetal resin, there are given binders of inks or coating materials.

When a polyvinyl acetal resin is used as the binders of the inks or the coating materials, significantly many cases use polyvinyl acetal as print ink of packaging materials, particularly packaging materials of foods, which are highly fancified. Because such ink for packaging materials of foods is require to be fancified but simultaneously has a high general purpose, a conventional method in which coating and drying are conducted in a solvent system is still main rather than a method of printing through a special technique such as a ultraviolet (UV) curing recently noted. And, since there is a possibility that a package printed with a printing ink directly contacts with a mouth, not only an amount of solvents and resins to be used, but also species thereof are regulated. Among them, the reason why polyvinyl acetal resin is used is that the polyvinyl acetal resin itself has fewer effects on environment issues and has very high solubility in ethanol.

However, there have been problems that the polyvinyl acetal resin is low in adhesion to a substrate, especially a resin film to some extent, and particularly when its storage environment was changed from in a refrigerator to under room temperature environment, ink itself absorbs moisture due to condensation of films and consequently ink peeled off from a substrate.

And, a warranty period of foods is shortened as the oxygen transmittance of the substrate film increases. The reason for this is that the oxygen in air permeates through the substrate film, and oxidizes and degrades foods within the substrate film. To this situation, it is possible to use a film having low oxygen transmittance such as vinylidene chloride, EVAL, etc., but since because of the high cost of these films, low-cost olefinic films having high oxygen transmittance such as polypropylene, polyethylene, etc. are mainly used and further the polyvinyl acetal resin used as ink is also easily permeable to oxygen, nitrogen, carbon dioxide, steam etc., there have been problems that the oxygen transmittance of the substrate film became high and the warranty period of foods was shortened.

As one of uses of a polyvinyl acetal resin, there is given an adhesive.

Conventionally, adhesives based on a polyvinyl acetal resin and a thermosetting resin such as a phenol resin, an epoxy resin or a melamine resin are widely used as an adhesive for a printed circuit board.

The printed circuit board is generally constructed by using a laminated plate composed of copper foil, phenol-impregnated paper and an adhesive which bonds them, and a printed circuit board, in which a desired printed circuit is formed, can be obtained by etching copper on the surface of a copper-plated laminated plate. In recent years, as various electronic and electric equipments is reduced in weight and downsized, downsizing and integration of a printed circuit are accelerated in the printed circuit board. Consequently, a time of immersion in a solder bath in mounting electronic devices on the printed circuit board is extended. Therefore, as an adhesive for constructing the printed circuit board, an adhesive exhibiting heat resistance superior to the conventional one is required and it is intensively desired, particularly, to improve adhesive strength of copper foil under high temperature conditions, namely to improve peeling strength of copper foil and to improve solder heat resistance.

For these situations, in Japanese Kokai Publication Sho-58-3802, there is disclosed an adhesive in which the heat resistance of polyvinyl acetal resin itself is enhanced by acetalizing a mixture of polyvinyl acetal resins; in Japanese Kokai Publication Sho-58-98307, there is disclosed an adhesive in which the adhesive strength and the heat resistance are enhanced by introducing maleic anhydride or maleic acid into mixed acetal; and in Japanese Kokai Publication Sho-63-301208, there is disclosed an adhesive in which the heat resistance is enhanced by constructing the adhesive in such a way that an acetalized portion derived from acetaldehyde having a high glass transition temperature makes up about 85 to 100 weight % of a total acetalized portion. However, because a time of immersion in a solder bath has been significantly extended, the heat resistance, which these polyvinyl acetal resins have, has still been insufficient.

Recently, as disclosed in Japanese Kokai Publication Hei-9-504970, there is known a method of fabricating a multilayer printed circuit board by superposing copper foil with an adhesive on a prepreg formed by impregnating a glass cloth or the like with an epoxy resin, etching copper on the surface of a copper-plated laminated plate and forming a through hole, and again superposing copper foil with an adhesive thereon, and etching and forming a through hole similarly. As the adhesive used then, there is known an adhesive which is based on an epoxy resin and formed by adding a polyvinyl acetal resin as for a thermosetting resin, but this adhesive is also intensively desired to improve heat resistance, and its heat resistance has still been insufficient.

Further, since a polyvinyl acetal resin has a hydroxyl group in a molecule thereof, an adhesive layer absorbs moisture at the time of high humidities such as summer, and therefore there has been a problem of deteriorated solder heat resistance.

And, as one of uses of a polyvinyl acetal resin, there is given a thermal developing photosensitive material.

A thermal developing photosensitive material is formed by coating compositions obtained by dispersing primarily silver salt of a fatty acid, an organic reducing agent and, in some cases, a small amount of photosensitive silver halide in a polymer binder on a supporting member.

Though a silver halide material conventionally used widely is utilized in the fields of image forming as materials of a wide use and high quality because of its excellent photographic properties, since development and fixing are complex and moreover a treatment process is wet type, there was a problem that treatment was complicated and a large amount of chemical waste solution was emitted. To this problem, a thermal developing photosensitive material, in which a developing process was performed by heat treatment, has been developed and commercialized.

For example, in Japanese Kokoku Publication Sho-43-4924, there is disclosed a thermal developing photosensitive material consisting of an organic silver salt, a reducing agent and a silver halide contacting with an organic silver ion catalytically, and for example, a thermal developing photosensitive material formed by applying a binder having a film forming property such as polyvinyl butyral, polymethyl methacrylate, cellulose acetate, polyvinyl acetate, cellulose acetate propionate, cellulose acetate butyrate, etc. to a supporting member such as paper, a plastic film, metal foil, a glass plate is disclosed.

Though the polyvinyl acetal resin is most suitable as the above-mentioned binder having a film forming property, there has been cases where fog, defective color tone and insufficient sensitivity occurred in image characteristics after coating or secular degradation arose during storing a raw film and a film after forming images due to the hygroscopicity of the polyvinyl acetal resin and a water content remaining. Further, since there are generally various polyvinyl acetal resins having different composition and furthermore it contains a trace amount of impurities in terms of production method, there has been cases where a prepared binder solution generated developed photosensitivity to result in coloring, or fog, defective color tone and insufficient sensitivity occurred in image characteristics after coating, or a defective storage stability of a raw film arose due to these impurities.

To this situation, a silver salt, a reducing agent, an additive and the like have been improved. For example, in Japanese Kokai Publication Sho-49-52626, there is disclosed a technique which uses a polyvinyl butyral resin as a binder, does not contain an independent stabilizer and an independent stabilizer precursor and uses a silver salt of a thion-compound. But, there is not disclosed a technique which resolves problems by specifying the composition of a binder.

Furthermore, in a thermal developing type of silver salt film of thermal developing photosensitive materials, because its image characteristics, especially image density, definition of images/tone portion is inferior to that of a conventional X-ray sensitive film using wet gelatin to a certain extent, improvements in these characteristics are desired, and to do so, it is necessary to control stringently a nucleus growth of silver in heating the photosensitive material.

And, as one of uses of a polyvinyl acetal resin, there is given a laminated ceramic condenser.

When the laminated ceramic condenser is fabricated, it is generally fabricated through the following steps. First, a binder resin and a plasticizer are added to a dispersion formed by dispersing ceramic powder in an organic solvent, and the mixture is mixed homogeneously with a mixing apparatus such as a ball mill and deaerated to prepare a slurry composition. Then, the slurry composition is applied onto a releasable supporting member using a doctor blade, a three roll reverse coater, etc., and the applied slurry composition is heated to be dried and then the dried coating is peeled off from the supporting member to obtain a green sheet. A laminate is obtained by superposing two or more sheets of processed ceramic green sheets which is formed by applying a conductive paste to become an internal electrode onto the obtained ceramic green sheet by screen process printing and by thermally attaching the processed ceramic green sheet to another by pressure. A laminated ceramic condenser can be obtained by cutting the laminate to the predetermined shape and dimensions, and by sintering an external electrode on the end face of the ceramic sintered body obtained by sintering.

For such a green sheet, a polyvinyl acetal resin such as a polyvinyl butyral resin is used for improving handling, and for example, some polyvinyl acetal resins are disclosed in Japanese Kokai Publication Hei-3-197511, Japanese Kokai Publication Hei-3-200805, Japanese Kokai Publication Hei-4-175261, Japanese Kokai Publication Hei-4-178404 and the like.

In recent years, a compact laminated ceramic condenser with a large capacity is required as electronic equipment is downsized. As a method of responding to such a requirement, there is made attempts to superpose a thin layer ceramic green sheet (for example, a thickness of 3 μm or smaller), obtained by using ceramic powder having a particle diameter (for example, 0.3 μm or smaller) finer than a conventional one, by 500 sheets or more.

However, when ceramic powder has a smaller particle diameter, the surface area of powder increases and therefore an amount of a binder to be added needs to increase. Accordingly, since the viscosity of slurry became high, not only handling became difficult, but also there have been problems that the ceramic powder tended to flocculate and viscosity increased with time.

And, in order to superpose such a thin layer ceramic green sheet by 500 sheets or more, an adhesive property in being thermally attached to another by pressure, releasability from a supporting member and strength of a green sheet become very important. For example, in order to improve the ability of the green sheet to be thermally attached to another by pressure, it is effective to uses a polyvinyl acetal resin having a high acetalization degree and a small amount of a hydroxyl group, or having a low polymerization degree, but there was the case where the ceramic green sheet became difficult to be released from a supporting member and the green sheet was flexible and did not have the strength to be impervious to releasing in a releasing process, and as a result there have been problems that the green sheet broke or stretched extraordinarily. In order to improve the releasability from a supporting member and the strength of a green sheet, it is effective to uses a polyvinyl acetal resin having a low acetalization degree and a large amount of a hydroxyl group, or having a high polymerization degree, but there have been problems that since an adhesive property in being thermally attached to another by pressure was low, the green sheet peeled off from the surface of a laminate after being attached to another by pressure and in the case of using the polyvinyl acetal resin having a high polymerization degree, the viscosity of slurry became high and consequently the slurrying became difficult.

On the other hand, though it is also conceivable to improve the ability of the green sheet to be thermally attached to another by pressure by increasing the amount of a plasticizer to be added, there has been a problem in a storage stability of a green sheet since an excessive addition of a plasticizer caused a shrinkage rate in sintering to deteriorate or the plasticizer to bleed out with time in the case of storing as the green sheet.

And, when number of laminated layers is many, decomposition of a binder in a debinder process hardly proceeds thoroughly and a decomposition product of a binder remains as a residue in the ceramic green sheet and consequently this sometimes deteriorated electrical characteristics. Further, in a substrate such as low temperature cofired ceramic substrate (LTCC) which uses glass powder and a copper wire as an electrode, a binder needs to thermally decompose thoroughly at 500° C. or lower, electrical characteristics sometimes deteriorated when the thermal decomposition was not perfect. Here, the polyvinyl acetal resin had a problem that it had a poor thermal decomposition property and ash remained after sintering.

Furthermore, since a laminated ceramic condenser, in which a thinner layer of a green sheet has increased, becomes subject to an external environment of a green sheet, particularly moisture, there has been a problem that the strength and the flexibility of a sheet varied with time and a ratio of a conforming item was deteriorated when a hygroscopic binder was used.

Thus, it has been desired for the modified polyvinyl acetal resin that the solution viscosity thereof was reduced in response to higher solid contents for improvement in flexibility and an environmental protection and the secular stability of viscosity was improved. And, when the modified polyvinyl acetal resin was used as a binder of ink or a coating material, it has been desired that the adhesion to a resin substrate particularly under high humidity conditions was improved and the oxygen transmittance was reduced to prolong a warranty period of foods. And, when it was employed in the adhesives for a printed circuit board, improvement in heat resistance such as solder heat resistance and peeling strength of metal foil under high temperature conditions and improvement in solder heat resistance in high humidities have been desired. And, when it was employed in the thermal developing photosensitive material, it has been desired to improve a storage stability of raw film, a storage stability of film after forming images and image characteristics by improving humidity resistance and reducing a water content. And, when it is employ in a slurry composition for a ceramic green sheet, it has been required to improve a thermal decomposition property and humidity resistance, and when it is used in a green sheet, it has been required to have a balanced adhesive property in which an adhesive property and sheet strength in thermally attaching by pressure and releasability from a supporting member can go hand in hand.

### SUMMARY OF THE INVENTION

It is an object of the present invention to provide a modified polyvinyl acetal resin, which is superior in flexibility, an adhesive property to a resin substrate under high humidities, heat resistance, a thermal decomposition property, humidity resistance and toughness and has low oxygen permeability and an adequate adhesive property and is low in viscosity and high in secular stability of viscosity in forming a solution thereof, and an adhesive composition, an ink, a coating material composition, a thermal developing photosensitive material, a slurry composition for a ceramic green sheet, and a ceramic green sheet, which use the modified polyvinyl acetal resin.

The first present invention is a modified polyvinyl acetal resin, which is obtainable by acetalizing a modified polyvinyl alcohol having ethylene in a random basis as a constituent unit of a main chain and an ethylene content of 1 to 20 mole % and a saponification degree of 80 mole % or more and, has ethylene in a random basis as a constituent unit of a main chain.

The second present invention is a modified polyvinyl acetal resin, which is obtainable by acetalizing a mixture of polyvinyl alcohols containing at least a modified polyvinyl alcohol having ethylene in a random basis as a constituent unit of a main chain and an ethylene content of 1 to 20 mole % as a whole and a saponification degree of 80 mole % or more as a whole and, has ethylene in a random basis as a constituent unit of a main chain.

Preferably, the modified polyvinyl acetal resins of the first present invention and the second present invention has an acetalization degree of 40 to 80 mole %, and is one acetalized by butyl aldehyde and/or acetaldehyde, and contains water in an amount of 2.5 weight % or less and aldehyde in an amount of 100 ppm or less.

The third present invention is an ink which is obtainable by using the modified polyvinyl acetal resin of the first present invention or the second present invention.

The fourth present invention is a coating material which is obtainable by using the modified polyvinyl acetal resin of the first present invention or the second present invention.

The fifth present invention is an adhesive which comprises the modified polyvinyl acetal resin of the first present invention or the second present invention and at least one thermosetting resin selected from the group consisting of a phenolic resin, an epoxy resin and a melamine resin.

The sixth present invention is a thermal developing photosensitive material which is obtainable by using the modified polyvinyl acetal resin of the first present invention or the second present invention.

The seventh present invention is a slurry composition for a ceramic green sheet, which comprises the modified vinyl acetal resin of the first present invention or the second present invention, ceramic powder, a plasticizer and an organic solvent. A ceramic green sheet which is obtainable by using the slurry composition for a ceramic green sheet of the seventh present invention is also one of the present invention.

### DETAILED DISCLOSURE OF THE INVENTION

Hereinafter, the present invention will be described in detail.

A modified polyvinyl acetal resin of the first present invention is obtainable by acetalizing a modified polyvinyl alcohol and has ethylene in a random basis as a constituent unit of a main chain. By having ethylene in a random basis as a constituent unit of a main chain, the modified polyvinyl acetal resin can reduce the viscosity of a solution thereof and attain effects of obtaining the secular stability of viscosity and improving flexibility, heat resistance, an adhesive property, humidity resistance, a thermal decomposition property, solvent solubility and the like.

Here, in this specification, having ethylene in a random basis as a constituent unit of a main chain means that all of ethylene units in a molecule are not combined into one but ethylene units in a molecule are located in a state of being separated into two or more parts in main chain.

And, it is possible to verify through, for example, a glass transition temperature measured with a differential scanning calorimeter or solubility in an organic solvent that the modified polyvinyl acetal resin of the first present invention has ethylene in a random basis as a constituent unit of a main chain. In measuring the above-mentioned glass transition temperature, only one glass transition temperature appears when the modified polyvinyl acetal resin has ethylene in a random basis as a constituent unit of a main chain, and two glass transition temperatures appear when the ethylene units exist in a state of a block. In verification through the above-mentioned solubility in an organic solvent, when the modified polyvinyl acetal resin has ethylene in a random basis as a constituent unit of a main chain, it is dissolved thoroughly in an organic solvent such as a mixed solution of ethanol and toluene having a weight ratio of 1:1, methyl ethyl ketone, etc. When the ethylene units exist in a state of a block, the modified polyvinyl acetal resin is low in the solubility in an organic solvent and generates an undissolved matter in being dissolved.

The above-mentioned modified polyvinyl alcohol is not particularly limited as long as it has ethylene in a random basis as a constituent unit of a main chain, and for example, a substance formed by saponifying a copolymer of vinyl ester and ethylene, a substance formed by saponifying a copolymer of vinyl ester, ethylene and ethylenic unsaturated monomer, end modified polyvinyl alcohol and the like are given. Because the above-mentioned modified polyvinyl alcohol has ethylene in a random basis as a constituent unit of a main chain, water solubility required for performing an acetalization reaction is enhanced and the modified polyvinyl acetal resin, which is obtained by acetalization, of the first present invention has ethylene in a random basis as a constituent unit of a main chain.

Further, the randomness of an ethylene unit in a main chain of the above-mentioned modified polyvinyl alcohol can be controlled by adjusting, for example, a polymerization initiator, a polymerization temperature, an addition technique of monomer, a polymerization time and the like in copolymerization. And, it is possible to verify through, for example, water solubility that the modified polyvinyl alcohol has ethylene in a random basis as a constituent unit of a main chain. When the modified polyvinyl alcohol has ethylene in a random basis as a constituent unit of a main chain, it is dissolved thoroughly in water, and when the ethylene units exist in a state of a block, the modified polyvinyl alcohol is low in water solubility and generates an undissolved matter in being dissolved in water.

The above-mentioned vinyl ester is not particularly limited and, for example, vinyl formate, vinyl acetate, vinyl propionate, vinyl pivalate and the like are given. Among them, vinyl acetate is economically preferable.

The above-mentioned ethylenic unsaturated monomer is not particularly limited, and for example, acrylic acid, methacrylic acid, phthalic acid, phthalic anhydride, maleic acid, maleic anhydride, itaconic acid, itaconic anhydride, acrylonitrile, methacrylonitrile, acrylamide, methacrylamide, trimethyl-(3-acrylamide-3-dimethylpropyl)-ammonium chloride, acrylamide-2-methylpropanesulfonic acid and sodium salt thereof, ethyl vinyl ether, butyl vinyl ether, N-vinylpyrrolidone, vinyl chloride, vinyl bromide, vinyl fluoride, vinylidene chloride, vinylidene fluoride, tetrafluoroethylene, vinylsulfonic acid sodium, allylsulfonic acid sodium and the like are given.

The above-mentioned end modified polyvinyl alcohol is formed by saponifying a copolymer of vinyl ester monomer such as vinyl acetate and ethylene in the presence of a thiol compound of thiol acid such as thiolacetic acid and mercaptopropione acid.

An blending amount of ethylenic unsaturated monomer, which is blended in preparing a copolymer of the above vinyl ester, ethylene and ethylenic unsaturated monomer, is preferably less than 2.0 mole %. When many units derived from ethylenic unsaturated monomer is contained, modified polyvinyl alcohol hardly has sufficient water solubility and in forming a solution of the modified polyvinyl acetal resin of the first present invention, the secular stability of viscosity may become poor. Particularly, the above-mentioned modified polyvinyl alcohol is preferably one which does not contain units derived from ethylenic unsaturated monomer.

The above-mentioned modified polyvinyl alcohol has an ethylene content of 1 to 20 mole %. When the ethylene content is less than 1 mole %, the flexibility and the heat resistance of the modified polyvinyl acetal resin of the first present invention are deteriorated, and the modified polyvinyl acetal resin has a small effect of lowering viscosity in forming a solution thereof and is low in secular stability of viscosity, and cannot adequately attain effects of improving an adhesive property, humidity resistance and a thermal decomposition property. When it is more than 20 mole %, since the water solubility of the modified polyvinyl alcohol is lowered, an acetalization reaction becomes difficult, or the modified polyvinyl acetal resin of the first present invention to be obtained has lower solvent solubility, or lower secular stability of viscosity of a solution thereof. Incidentally, in this specification, an ethylene content represents a ratio of number of ethylene units to total number of monomer units composing the modified polyvinyl alcohol.

Because the above-mentioned modified polyvinyl alcohol has the ethylene content of 1 to 20 mole %, the modified polyvinyl acetal resin of the first present invention, which is obtained by acetalizing the modified polyvinyl alcohol, also has an ethylene content of 1 to 20 mole %.

The above-mentioned modified polyvinyl alcohol has a saponification degree of 80 mole % or higher. When the saponification degree is lower than 80 mole %, an acetalization reaction becomes difficult since the water solubility of the modified polyvinyl alcohol is lowered and an acetalization reaction itself becomes difficult since number of hydroxyl groups becomes less.

The above-mentioned acetalization can be conducted by adding aldehyde to an aqueous solution of the above-mentioned modified polyvinyl alcohol and following a publicly known method.

The above-mentioned aldehyde is not particularly limited, and for example, formaldehyde (including p-formaldehyde), acetaldehyde (including p-acetaldehyde), propionaldehyde, butylaldehyde, amylaldehyde, hexyl aldehyde, heptyl aldehyde, 2-ethylhexyl aldehyde, cyclohexyl aldehyde, furfural, glyoxal, glutaraldehyde, benzaldehyde, 2-methylbenzaldehyde, 3-methylbenzaldehyde, 4-methylbenzaldehyde, p-hydroxybenzaldehyde, m-hydroxybenzaldehyde, phenylacetaldehyde, β-phenylpropionaldehyde and the like are given. Among them, acetaldehyde and/or butylaldehyde is favorably used. These aldehyde may be used alone or in combination of two or more species.

An acetalization degree of the modified polyvinyl acetal resin of the first present invention is preferably 40 to 80 mole % whether the acetalization is performed by a kind of aldehyde or by a mixture of two or more kinds of aldehydes. When the acetalization degree is less than 40 mole %, the modified polyvinyl acetal resin of the first present invention become soluble in water and insoluble in an organic solvent. When it is more than 80 mole %, number of residual hydroxyl groups becomes less and the toughness of the modified polyvinyl acetal resin of the first present invention may be impaired. In addition, a more favorable range may be selected for the above-mentioned acetalization degree, depending on uses of the modified polyvinyl acetal resin of the first present invention.

Incidentally, in this specification, because an acetal group is formed from two hydroxyl groups by acetalization, the acetalization degree refers to an acetalization degree (mole %) in the case of counting an acetal group as two hydroxyl groups to calculate the acetalization degree.

An polymerization degree of the modified polyvinyl acetal resin of the first present invention is not particularly limited but it is preferably 50 to 3,500. When the polymerization degree is within this range, it is possible to produce the modified polyvinyl acetal resin of the first present invention and the above-mentioned modified polyvinyl alcohol with high productivity. The polymerization degree is more preferably 200 to 3,500. In addition, a more favorable range may be selected for the above-mentioned polymerization degree, depending on uses of the modified polyvinyl acetal resin of the first present invention.

A water content of the modified polyvinyl acetal resin of the first present invention is preferably 2.5 weight % or lower. When the water content is more than 2.5 weight %, the modified polyvinyl acetal resin may not exert its characteristics adequately in the case of being used in the thermal developing photosensitive material of the sixth present invention described later. As a method of reducing the above-mentioned water content to 2.5 weight % or lower, there is given a method of cleaning a product after an acetalization reaction with water or a mixed solution of water and alcohol and then reducing the water content below a specified level by drying. It is more preferably 2.0 weight % or lower.

An amount of aldehyde of the modified polyvinyl acetal resin of the first present invention is preferably 100 ppm or lower. When the amount of aldehyde is more than 100 ppm, the modified polyvinyl acetal resin may not exert its characteristics adequately in the case of being used in the thermal developing photosensitive material of the sixth present invention described later. As a method of reducing the above-mentioned amount of aldehyde to 100 ppm or lower, there is given a method of purifying a product by cleaning with water or a mixed solution of water and alcohol to reduce the amount of aldehyde to a specified level or below. It is more preferably 50 ppm or lower, furthermore 10 ppm or lower.

As a specific method of producing the modified polyvinyl acetal resin of the first present inventions, there are given, for example, a method of dissolving the modified polyvinyl alcohol in a solvent, reacting the solution with a predetermined amount of aldehydes so as to provide the modified polyvinyl acetal resin with a desired acetalization degree in the presence of an acid catalyst, terminating an acetalization reaction with an alkali or a terminator, and then water washing and drying a product.

The above-mentioned solvent is not particularly limited and there is given, for example, water, alcohol, a mixed solvent of water and alcohol, dimethylsulfoxide (DMSO), etc.

The above-mentioned acid catalyst is not specifically limited and both of an organic acid and an inorganic acid can be used, and for example, acetic acid, p-toluene sulfonic acid, nitric acid, sulfuric acid, hydrochloric acid, etc. are given.

The above-mentioned alkali is not particularly limited and, for example, sodium hydroxide, potassium hydroxide, ammonium, sodium acetate, sodium carbonate, sodium hydrogencarbonate and potassium carbonate, etc. are given.

The above-mentioned terminator is not particularly limited and, for example, alkylene oxide such as ethylene oxide, glycidyl ether such as ethylene glycol diglycidyl ether and the like are given.

The modified polyvinyl acetal resin of the first present invention is formed by acetalizing a modified polyvinyl alcohol having ethylene in a random basis as a constituent unit of a main chain and having a predetermined ethylene content and a predetermined saponification degree, and since the hydrogen bond strength of a hydroxyl group contained in the modified polyvinyl acetal resin is weakened, a solution of the modified polyvinyl acetal resin has low viscosity and high secular stability of viscosity and can form a coat with high flexibility. Such the modified polyvinyl acetal resin of the first present invention can be effectively used in application areas such as ceramics, inks, coating materials, adhesives, special coatings, various binders, etc.

The modified polyvinyl acetal resin of the second present invention is formed by acetalizing a mixture of polyvinyl alcohols and has ethylene in a random basis as a constituent unit of a main chain. By having ethylene in a random basis as a constituent unit of a main chain, the modified polyvinyl acetal resin can reduce the viscosity of a solution thereof and attain effects of obtaining the secular stability of viscosity and improving flexibility, heat resistance, an adhesive property, humidity resistance, a thermal decomposition property, solvent solubility and the like. Here, the modified polyvinyl acetal resin, having ethylene in a random basis as a constituent unit of a main chain, of the second present invention means a modified polyvinyl acetal resin containing modified polyvinyl acetal having ethylene in a random basis as a constituent unit of a main chain and may contain unmodified polyvinyl acetal in part. And, it is possible to verify through, for example, the glass transition temperature of modified polyvinyl acetal, which is measured with a differential scanning calorimeter, or the solubility of modified polyvinyl acetal in an organic solvent that the modified polyvinyl acetal in the modified polyvinyl acetal resin of the second present invention has ethylene in a random basis as a constituent unit of a main chain. In the above-mentioned measurement of the glass transition temperature, only one glass transition temperature appears when the modified polyvinyl acetal resin has ethylene in a random basis as a constituent unit of a main chain, and two glass transition temperatures appear when the ethylene units exist in a state of a block. In verification of the above-mentioned solubility in an organic solvent, when the modified polyvinyl acetal resin has ethylene in a random basis as a constituent unit of a main chain, it is dissolved thoroughly in an organic solvent such as a mixed solution of ethanol and toluene having a weight ratio of 1:1, methyl ethyl ketone, etc. When the ethylene units exist in a state of a block, the modified polyvinyl acetal resin is low in the solubility in an organic solvent and generates an undissolved matter in being dissolved.

The above-mentioned mixture of polyvinyl alcohols consists of two or more kinds of polyvinyl alcohols and contains at least modified polyvinyl alcohol having ethylene in a random basis as a constituent unit of a main chain and may contain unmodified polyvinyl alcohol.

The above-mentioned modified polyvinyl alcohol of the second present invention is not particularly limited as long as it has ethylene in a random basis as a constituent unit of a main chain, and for example, a substance formed by saponifying a copolymer of vinyl ester and ethylene, a substance formed by saponifying a copolymer of vinyl ester, ethylene and ethylenic unsaturated monomer, end modified polyvinyl alcohol and the like are given. Because the above-mentioned modified polyvinyl alcohol of the second present invention has ethylene in a random basis as a constituent unit of a main chain, water solubility required for performing an acetalization reaction is enhanced and the modified polyvinyl acetal resin, which is obtained by acetalization, of the second present invention has ethylene in a random basis as a constituent unit of a main chain. Further, the randomness of an ethylene unit in a main chain of the above-mentioned modified polyvinyl alcohol of the second present invention can be controlled by adjusting, for example, a polymerization initiator, a polymerization temperature, an addition technique of monomer and a polymerization time in copolymerization.

The above-mentioned polyvinyl alcohol mixture has an overall ethylene content of 1 to 20 mole %. When the ethylene content is less than 1 mole %, the flexibility and the heat resistance of the modified polyvinyl acetal resin of the second present invention are deteriorated, and the modified polyvinyl acetal resin has a small effect of lowering viscosity in forming a solution thereof and is low in secular stability of viscosity, and cannot adequately attain effects of improving an adhesive property, humidity resistance and a thermal decomposition property. When it is more than 20 mole %, since the water solubility of the polyvinyl alcohol mixture is lowered, an acetalization reaction becomes difficult, or the modified polyvinyl acetal resin of the second present invention to be obtained has lower solvent solubility, or lower secular stability of viscosity of a solution thereof.

Here, in this specification, the overall ethylene content (mole %) of the above-mentioned polyvinyl alcohol mixture is determined by multiplying the ethylene content of each polyvinyl alcohol composing the above-mentioned polyvinyl alcohol mixture by a weight ratio of each polyvinyl alcohol to calculate each product and summing these product. Here, an ethylene content of unmodified polyvinyl alcohol is assumed 0 mole %. For example, as for a polyvinyl alcohol mixture consisting of modified polyvinyl alcohol A and modified polyvinyl alcohol B, an overall ethylene content (mole %) is given from the following formula (1).

X=(A₁×A₂+B₁×B₂)/(A₁+B₁) (1)

In the formula (1), X represents an overall ethylene content of a polyvinyl alcohol mixture, A₁ represents weight of polyvinyl alcohol A, A₂ represents an ethylene content of polyvinyl alcohol A, B₁ represents weight of polyvinyl alcohol B, and B₂ represents an ethylene content of polyvinyl alcohol B.

And, though the overall ethylene content (mole %) of the modified polyvinyl acetal resin of the second present invention can also be determined by a similar method, since this ethylene content is identical to the value of a polyvinyl alcohol mixture antecedent to acetalization, in the case where the ethylene content of each of polyvinyl alcohols composing the modified polyvinyl alcohol mixture is known, the overall ethylene content of the modified polyvinyl acetal resin can be determined by using each ethylene content. And, because the polyvinyl alcohol mixture has the overall ethylene content of 1 to 20 mole %, the modified polyvinyl acetal resin of the second present invention, which is obtained by acetalizing the polyvinyl alcohol mixture, also has the overall ethylene content of 1 to 20 mole %.

The above-mentioned polyvinyl alcohol mixture has an overall saponification degree of 80 mole % or higher. When the saponification degree is lower than 80 mole %, an acetalization reaction becomes difficult since the water solubility of the polyvinyl alcohol mixture is lowered and an acetalization reaction itself becomes difficult because number of hydroxyl groups becomes less.

Here, in this specification, the overall saponification degree (mole %) of the above-mentioned polyvinyl alcohol mixture is determined by multiplying the saponification degree of each polyvinyl alcohol composing the above-mentioned polyvinyl alcohol mixture by a weight ratio of each polyvinyl alcohol to calculate each product and summing these product. For example, as for a polyvinyl alcohol mixture consisting of modified polyvinyl alcohol A and modified polyvinyl alcohol B, an overall saponification degree (mole %) is given from the following formula (2).

Y=(A₁×A₃+B₁×B₃)/(A₁+B₁) (2)

In the formula (2), Y represents an overall saponification degree of a polyvinyl alcohol mixture, A₁ represents weight of polyvinyl alcohol A, A₃ represents a saponification degree of polyvinyl alcohol A, B₁ represents weight of polyvinyl alcohol B, and B₃ represents a saponification degree of polyvinyl alcohol B.

And, though the overall saponification degree (mole %) of the modified polyvinyl acetal resin of the second present invention can also be determined by a similar method, since this saponification degree is identical to the value of a polyvinyl alcohol mixture antecedent to acetalization, in the case where the saponification degree of each of polyvinyl alcohols composing the modified polyvinyl alcohol mixture is known, the overall saponification degree of the modified polyvinyl acetal resin can be determined by using each saponification degree. And, because the polyvinyl alcohol mixture has the overall saponification degree of 80 mole % or higher, the modified polyvinyl acetal resin of the second present invention, which is obtained by acetalizing the polyvinyl alcohol mixture, also has the overall saponification degree of 80 mole % or higher.

The above-mentioned acetalization of the second present invention can be conducted by adding aldehyde to an aqueous solution of the above-mentioned polyvinyl alcohol mixture and following a publicly known method.

An acetalization degree of the modified polyvinyl acetal resin of the second present invention is preferably 40 to 80 mole % whether the acetalization is performed by a kind of aldehyde or by a mixture of two or more kinds of aldehydes. When the acetalization degree is less than 40 mole %, the modified polyvinyl acetal resin of the second present invention becomes soluble in water and insoluble in an organic solvent. When it is more than 80 mole %, number of residual hydroxyl groups becomes less and the toughness of the modified polyvinyl acetal resin of the second present invention may be impaired. In addition, a more favorable range may be selected for the above-mentioned acetalization degree, depending on uses of the modified polyvinyl acetal resin of the second present invention.

An polymerization degree of the modified polyvinyl acetal resin of the second present invention is not particularly limited but it is preferably 50 to 3,500. When the polymerization degree is within this range, it is possible to produce the modified polyvinyl acetal resin and the modified polyvinyl alcohol of the second present invention with high productivity. The polymerization degree is more preferably 200 to 3,500. In addition, a more favorable range may be selected for the above-mentioned polymerization degree, depending on uses of the modified polyvinyl acetal resin of the second present invention. And, in this specification, the polymerization degree of the modified polyvinyl acetal resin of the second present invention is determined by multiplying the polymerization degree of each component composing the modified polyvinyl acetal resin of the second present invention by a weight ratio of each component to calculate each product and summing these product.

A water content of the modified polyvinyl acetal resin of the second present invention is preferably 2.5 weight % or lower. When the water content is more than 2.5 weight %, the modified polyvinyl acetal resin may not exert its characteristics adequately in the case of being used in the thermal developing photosensitive material of the sixth present invention described later. As a method of reducing the above-mentioned water content to 2.5 weight % or lower, there is given a method of cleaning a product after an acetalization reaction with water or a mixed solution of water and alcohol and then reducing the water content below a specified level by drying. It is more preferably 2.0 weight % or lower.

An amount of aldehyde of the modified polyvinyl acetal resin of the second present invention is preferably 100 ppm or lower. When the amount of aldehyde is more than 100 ppm, the modified polyvinyl acetal resin may not exert its characteristics adequately in the case of being used in the thermal developing photosensitive material of the sixth present invention described later. As a method of reducing the above-mentioned amount of aldehyde to 100 ppm or lower, there is given a method of purifying a product by cleaning with water or a mixed solution of water and alcohol to reduce the amount of aldehyde below a specified level. It is more preferably 50 ppm or lower, furthermore 10 ppm or lower.

As a specific method of producing the modified polyvinyl acetal resin of the second present inventions, there are given, for example, a method of dissolving the polyvinyl alcohol mixture in a solvent, reacting the solution with a predetermined amount of aldehydes so as to provide the modified polyvinyl acetal resin with a desired acetalization degree in the presence of an acid catalyst, terminating an acetalization reaction with an alkali or a terminator, and then water washing and drying a product.

The modified polyvinyl acetal resin of the second present invention is formed by acetalizing a mixture of polyvinyl alcohols having ethylene in a random basis as a constituent unit of a main chain and having a predetermined ethylene content and a predetermined saponification degree, and since the hydrogen bond strength of a hydroxyl group contained in the modified polyvinyl acetal resin is weakened, a solution of the modified polyvinyl acetal resin has low viscosity and high secular stability of viscosity and can form a coat with high flexibility. Such the modified polyvinyl acetal resin of the second present invention can be effectively used in application areas such as ceramics, inks, coating materials, adhesives, special coatings, various binders, etc.

The third present invention is an ink which is obtainable by using the modified polyvinyl acetal resin of the first present invention or the second present invention.

An acetalization degree of the modified polyvinyl acetal resin of the first present invention or the second present invention in the case of being used in the ink of the third present invention is more preferably 60 to 75 mole % whether the acetalization is performed by a kind of aldehyde or by a mixture of two or more kinds of aldehydes. When the acetalization degree is less than 60 mole %, the hydrophilicity of the modified polyvinyl acetal resin of the first present invention or the second present invention increases and its water resistance may be insufficient. When it is more than 75 mole %, number of residual hydroxyl groups becomes less and the solubility in an alcoholic solvent of the modified polyvinyl acetal resin of the first present invention or the second present invention may be insufficient.

An polymerization degree of the modified polyvinyl acetal resin of the first present invention or the second present invention in the case of being used in the ink of the third present invention is not particularly limited but it is preferably 50 to 3,500. When the polymerization degree is less than 50, production of polyvinyl alcohol, being a raw material, may become difficult. When it is more than 3,500, the solution viscosity of the ink of the third present invention become too high and therefore the ink is poor in dispersibility and homogeneous ink cannot be attained. The polymerization degree is more preferably 50 to 1,000.

The ink of the third present invention can be prepared by blending the polyvinyl acetal resin of the first present invention or the second present invention, pigments, organic solvents and the like and mixing them by an ordinary technique.

The amount of the above-mentioned modified polyvinyl acetal resin to be blended is preferably 5 to 25 weight % with respect to the total amount of the ink of the third present invention. When the amount to be blended is less than 5 weight %, a film forming property may become low in the case of forming a coat of ink. When it is more than 25 weight %, the solution viscosity of the ink becomes too high and therefore this may deteriorates the dispersibility of pigment. The amount of the modified polyvinyl acetal resin to be blended is more preferably 10 to 20 weight %.

The above-mentioned pigment is not particularly limited and, for example, inorganic pigments or organic pigments are given. The above-mentioned inorganic pigment is not particularly limited and, for example, titanium oxide, carbon black, etc. are given. The above-mentioned organic pigment is not particularly limited and, for example, diazo pigment, phthalocyanine pigment, etc. are given.

The amount of the above-mentioned pigment to be blended is preferably 15 to 30 weight % for thickened ink and preferably 10 to 15 weight % for diluted ink with respect to the total amount of the ink of the third present invention. When the amount to be blended is less than 10 weight %, the concentration of the applied ink is low and it may be impossible to develop an objective color tone. When it is more than 30 weight %, pigment cannot be dispersed and may flocculate.

The above-mentioned organic solvent is not particularly limited as long as it dissolves the modified polyvinyl acetal resin of the first present invention or the second present invention and provides the ink of the third present invention with an adequate kneading property, and ketones such as acetone, methyl ethyl ketone, etc.; alcohols such as methanol, ethanol, isopropanol, n-propanol, n-butanol, etc.; aromatic hydrocarbons such as toluene, xylene, etc., and esters such as methyl acetate, ethyl acetate, butyl acetate, etc. are given, and among them, alcoholic solvents are preferable from the viewpoint of environmental protection. These solvents may be used alone or in combination of two or more species.

The amount of the above-mentioned organic solvent to be blended is preferably 60 to 85 weight % with respect to the total amount of the ink of the third present invention.

In the ink of the third present invention, an adhesive promoter, a retarder, a plasticizer, a filler, a wax, a compatibilizing agent, a surfactant, a dispersant, a tackifier, etc. may be further blended as required.

Since the ink of the third present invention has the high secular stability of viscosity even when it is made higher solid contents by using the modified polyvinyl acetal resin of the first present invention or the second present invention, it can be used without problems even after being stored for long periods. And, since the ink of the third present invention has high adhesion to a resin substrate and excellent humidity resistance and has high adhesion to a resin substrate in high humidities, it may be effectively used for printing of the packaging materials of foods stored at low temperatures such as ice creams and chocolates. Further, since it is superior in a gas barrier property and has low oxygen transmittance, it may also prolong a warranty period of foods.

The fourth present invention is a coating material which is obtainable by using the modified polyvinyl acetal resin of the first present invention or the second present invention.

An acetalization degree of the modified polyvinyl acetal resin of the first present invention or the second present invention in the case of being used in the coating material of the fourth present invention is more preferably 60 to 75 mole % whether the acetalization is performed by a kind of aldehyde or by a mixture of two or more kinds of aldehydes. When the acetalization degree is less than 60 mole %, the hydrophilicity of the modified polyvinyl acetal resin of the first present invention or the second present invention increases and its water resistance may be insufficient. When it is more than 75 mole %, number of residual hydroxyl groups becomes less and the solubility in an alcoholic solvent of the modified polyvinyl acetal resin of the first present invention or the second present invention may be insufficient.

A polymerization degree of the modified polyvinyl acetal resin of the first present invention or the second present invention in the case of being used in the coating material of the fourth present invention is not particularly limited but it is preferably 50 to 3,500. When the polymerization degree is less than 50, production of polyvinyl alcohol, being a raw material, may become difficult. When it is more than 3,500, the solution viscosity of the coating material of the fourth present invention become too high and therefore the coating material is poor in dispersibility and homogeneous ink cannot be attained. The polymerization degree is more preferably 50 to 1,000.

The coating material of the fourth present invention can be prepared by blending the polyvinyl acetal resin of the first present invention or the second present invention, pigments, organic solvents and the like and mixing them by an ordinary technique.

The amount of the above-mentioned modified polyvinyl acetal resin to be blended is preferably 5 to 25 weight % with respect to the total amount of the coating material of the fourth present invention. When the amount to be blended is less than 5 weight %, a film forming property may become low in the case of forming a coat of the coating material. When it is more than 25 weight %, the solution viscosity of the coating material becomes too high and therefore this may deteriorates the dispersibility of pigment. The amount of the modified polyvinyl acetal resin to be blended is more preferably 10 to 20 weight %.

The above-mentioned pigment in the fourth present invention is not particularly limited and for example, inorganic pigments or organic pigments are given, and pigments similar to that in the ink of the third present invention can be employed.

The amount of the above-mentioned pigment to be blended is preferably 15 to 30 weight % for a thickened coating material and preferably 10 to 15 weight % for a diluted coating material product with respect to the total amount of the coating material of the fourth present invention. When the amount to be blended is less than 10 weight %, the concentration of the applied coating material is low and it may be impossible to develop an objective color tone. When it is more than 30 weight %, pigment cannot be dispersed and may flocculate.

The above-mentioned organic solvent in the coating material of the fourth present invention is not particularly limited as long as it dissolves the modified polyvinyl acetal resin of the first present invention or the second present invention and provides the coating material of the fourth present invention with an adequate kneading property, and for example, organic solvents similar to that in the ink of the third present invention can be employed. Particularly, alcoholic solvents are preferable from the viewpoint of environmental protection. These solvents may be used alone or in combination of two or more species.

The amount of the above-mentioned organic solvent to be blended is preferably 60 to 85 weight % with respect to the total amount of the coating material of the fourth present invention.

In the coating material of the fourth present invention, an adhesive promoter, a retarder, a plasticizer, a filler, a wax, a compatibilizing agent, a surfactant, a dispersant, a tackifier, etc. may be further blended as required.

Since the a coating material of the fourth present invention has the high secular stability of viscosity even when it is made higher solid contents by using the modified polyvinyl acetal resin of the first present invention or the second present invention, it can be used without problems even after being stored for long periods. And, since the coating material of the fourth present invention has high adhesion to a resin substrate and excellent humidity resistance and has high adhesion to a resin substrate in high humidities, it may be effectively used for printing of the packaging materials of foods stored at low temperatures such as ice creams and chocolates. Further, since it is superior in a gas barrier property and has low oxygen transmittance, it may also prolong a warranty period of foods.

The fifth present invention is an adhesive containing the modified polyvinyl acetal resin of the first present invention or the second present invention and at least one kind of thermosetting resin selected from the group consisting of a phenolic resin, an epoxy resin and a melamine resin.

An acetalization degree of the modified polyvinyl acetal resin of the present invention in the case of being used in the adhesive of the fifth present invention is more preferably 60 to 80 mole % whether the acetalization is performed by a kind of aldehyde or by a mixture of two or more kinds of aldehydes. When the acetalization degree is less than 60 mole %, the hydrophilicity of the modified polyvinyl acetal resin of the first present invention or the second present invention increases and its water resistance may be insufficient. When it is more than 80 mole %, number of residual hydroxyl groups becomes less and the toughness of the modified polyvinyl acetal resin of the first present invention or the second present invention may be impaired or the reactivity of the modified polyvinyl acetal resin with a thermosetting resin may be deteriorated.

A polymerization degree of the modified polyvinyl acetal resin of the first present invention or the second present invention in the case of being used in the adhesive of the fifth present invention is not particularly limited but it is more preferably 1,000 to 3,500. When the polymerization degree is less than 1,000, peel strength after adhesion may decrease, and when it is more than 3,500, since the solution viscosity of the adhesive become too high, a coating property is poor and a homogeneous coating composition cannot be attained. The polymerization degree is furthermore preferably 1,500 to 3,000.

A blending ratio by weigh of the modified polyvinyl acetal resin of the first present invention or the second present invention to the above-mentioned thermosetting resin in the adhesive of the fifth present invention is preferably 3:97 to 70:30. When the blending ratio of the modified polyvinyl acetal resin of the first present invention or the second present invention is less than 3, adhesion to copper foil may be deteriorated, and when it is more than 70, heat resistance may be deteriorated. Particularly, when a principal component of the above-mentioned thermosetting resin is a phenolic resin and/or a melamine resin, the blending ratio by weigh is more preferably 30:70 to 70:30, and when a principal component of the above-mentioned thermosetting resin is a epoxy resin, the blending ratio by weigh is more preferably 3:97 to 30:70.

The solvent used for preparation of the adhesive of the fifth present invention is not particularly limited and for example, ketones such as acetone, methyl ethyl ketone, etc.; alcohols such as methanol, ethanol and butanol; and aromatic hydrocarbons such as toluene, xylene, etc. are appropriately used.

The adhesive of the fifth present invention may contain a thermosetting resin and additives such as a curing agent, an antioxidant, an antifoaming agent, an antistatic agent and the like other than the above-mentioned substances, depending on the purposes such as improvement in heat resistance.

The adhesive of the fifth present invention has excellent heat resistance and high adhesive strength, particularly high heat-resisting adhesive strength, by containing the modified polyvinyl acetal resin of the first present invention or the second present invention since the modified polyvinyl acetal resin of the first present invention or the second present invention has high reactivity with a thermosetting resin and high moisture absorption. When the adhesive of the fifth present invention is used, for example, as an adhesive of a laminated plate of a printed circuit board, it can significantly improve heat resistance, particularly solder heat resistance, and peel strength, and the obtained copper foil with an adhesive has high solder heat resistance and high peel strength even when it is left alone in high humidities for long periods.

The sixth present invention is a thermal developing photosensitive material which is obtainable by using the modified polyvinyl acetal resin of the first present invention or the second present invention.

It is particularly preferable that the modified polyvinyl acetal resin of the first present invention or the second present invention in the case of being used in the thermal developing photosensitive material of the sixth present invention is a substance acetalized by acetaldehyde and/or butyl aldehyde, and thereby, the thermal developing photosensitive material of the sixth present invention become easy to attain the balanced image characteristics.

An acetalization degree of the modified polyvinyl acetal resin of the first present invention or the second present invention in the case of being used in the thermal developing photosensitive material of the sixth present invention is more preferably 65 to 80 mole % whether the acetalization is performed by a kind of aldehyde or by a mixture of two or more kinds of aldehydes. When the acetalization degree is less than 65 mole %, since the amount of hydroxyl group of the modified polyvinyl acetal resin of the first present invention or the second present invention is much, it becomes difficult to attain the balanced hydrophilicity and an organic acid produces a crystalline substance during storage of film after forming an image and therefore a problem that the surface of a coat become whitish may arise. When it is more than 80 mole %, number of residual hydroxyl groups becomes less and the toughness of the modified polyvinyl acetal resin of the first present invention or the second present invention may be impaired to lead to decrease in the strength of a coat or the dispersibility of silver halide may be deteriorated to lead to deterioration of image characteristics.

A polymerization degree of the modified polyvinyl acetal resin of the first present invention or the second present invention in the case of being used in the thermal developing photosensitive material of the sixth present invention is not particularly limited but it is more preferably 200 to 3,000. It is furthermore preferably 200 to 1,000, in which it is easy to have the balance between the dispersibility of silver salt, the strength of a coat and coating characteristics in the case of being used in the thermal developing photosensitive material of the sixth present invention.

The amount of residual acetyl groups of the modified polyvinyl acetal resin of the first present invention or the second present invention in the case of being used in the thermal developing photosensitive material of the sixth present invention is preferably 25 mole % or lower. When the amount of residual acetyl groups is higher than 25 mole %, blocking may arise between photosensitive films to be obtained or images may lose sharpness. It is more preferably 15 mole % or lower.

A water content of the modified polyvinyl acetal resin of the first present invention or the second present invention in the case of being used in the thermal developing photosensitive material of the sixth present invention is preferably 2.5 weight % or lower. When the water content is more than 2.5 weight %, there may be cases where the pot life of a coating solution decreases, a sufficient film strength is not attained due to a reaction with a crosslinking agent to be added for enhancement of the film strength, for example, a compound containing an isocyanate group or an excessive amount of the crosslinking agent causes fog if an addition rate of the crosslinking agent is increased in expectation of a reaction of the crosslinking agent with water. As a method of reducing the above-mentioned water content to 2.5 weight % or lower, there is given a method of cleaning a product after an acetalization reaction with water or a mixed solution of water and alcohol and then reducing the water content below a specified level by drying. It is more preferably 2.0 weight % or lower.

An amount of aldehyde of the modified polyvinyl acetal resin of the first present invention or the second present invention in the case of being used in the thermal developing photosensitive material of the sixth present invention is preferably 100 ppm or lower. When the amount of aldehyde is more than 100 ppm, aldehyde is reduced by a reducing agent contained in a coating solution, and this deteriorates a storage stability of the coating solution and causes decrease in a storage stability of raw film and an occurrence of fog. As a method of reducing the above-mentioned amount of aldehyde to 100 ppm or lower, there is given a method of purifying a product by cleaning with water or a mixed solution of water and alcohol to reduce the amount of aldehyde below a specified level. It is more preferably 50 ppm or lower, furthermore 10 ppm or lower.

Further, in the production of the modified polyvinyl acetal resin of the first present invention or the second present invention in the case of being used in the thermal developing photosensitive material of the sixth present invention, it is preferred no to use hindered phenolic antioxidants, bisphenolic antioxidants and phosphate-based antioxidants. Generally, in an acetalization reaction of modified polyvinyl alcohol and aldehyde, an antioxidant is added to a reaction system or a resin system in order to prevent the oxidation of aldehyde or modified polyvinyl acetal resin to be obtained and to improve heat resistance, but due to use of the antioxidant, it remains in the modified polyvinyl acetal resin of the first present invention or the second present invention and therefore there may be cases where it causes decrease in a pot life of a coating solution and decrease in a storage stability of raw film, and fog occurs and sharpness of images/gradations is impaired.

A composition of the thermal developing photosensitive material of the sixth present invention does not differ from a composition of the conventional thermal developing photosensitive material except for using the modified polyvinyl acetal resin of the first present invention or the second present invention. For example, in the modified polyvinyl acetal resin of the first present invention or the second present invention, an organic silver salt, a reducing agent, a small amount of photosensitive silver halide or a silver halide forming component, as required, a crosslinking agent, a sensitizer, etc. are blended, and a hue agent may be further blended when a black image is formed with silver, and a color coupler and leuco dye may be further blended when a colored image is formed.

A weight ratio of an amount of the modified polyvinyl acetal resin of the first present invention or the second present invention to be blended to the organic silver is preferably 1:10 to 10:1, more preferably 1:5 to 5:1.

The above-mentioned organic silver salt is a silver salt which is relatively stable for light and colorless or white.

The above-mentioned organic silver salt is not particularly limited as long as it reacts with a reducing agent and produces silver when it is heated to a temperature of 80° C. or higher in the presence of silver halide exposed to light, and for example, silver salts of an organic compound having a mercapto group, a thion group or a carboxyl group, and benzotriazole silver etc. are give. Specifically, silver salts of dithio carboxylic acid such as silver salt of a compound having a mercapto group or a thion group, silver salt of 3-mercapto-4-phenyl 1,2,4-triazole, silver salt of 2-mercapto-benzimidazole, silver salt of 2-mercapto-5-aminothiazole, silver salt of 1-phenyl-5-mercapto tetrathiazole, silver salt of 2-mercapto benzothiazole, silver salt of thioglycol acid and silver salt of dithioacetic acid; thioamide silver, thiopyridine silver salt, silver salt of mercaptooxadiazole, silver salt of mercaptotriazine, silver of aliphatic carboxylic acid, silver caprate, silver laurate, silver myristate, silver palmitate, silver stearate, silver behenate, silver maleate, silver fumarate, silver tartrate, silver furoinate, silver linoleate, silver oleate, silver hydroxystearate, silver adipate, silver sebacate, silver succinate, silver acetate and silver butyrate, silver camphorate; aromatic silver carboxylate, silver thion carboxylate, aliphatic silver carboxylate having thioether group, silver salt of tetra-diindene, silver S-2-aminophenyl-thiosulfate, amino alcohol including metal and organic acid metal chelate etc. are given. Among them, silver salt of aliphatic carboxylate is preferable and silver behenate is more preferable.

A particle diameter of the above-mentioned organic silver salt is preferably 0.01 to 10 μm, more preferably 0.1 to 5 μm.

A photosensitive silver halide may be contacted with the above-mentioned organic silver salt as a catalyst.

The above-mentioned photosensitive silver halide is not particularly limited and, for example, silver bromide, silver iodide, silver chloride, silver chlorobromide, silver bromoiodide, silver chloroiodide and the like are given.

A method of contacting the photosensitive silver halide with the above-mentioned organic silver salt as a catalyst is not particularly limited and, for example, a method of making a silver halide forming component react with a solution or a dispersion of an organic silver salt, which has been previously prepared, or with a film material containing an organic silver salt to convert a part of the organic silver to silver halide is given.

Though the above-mentioned photosensitive silver halide forming component is not particularly limited as long as it reacts with the organic silver salt to form silver halide, a substance containing iodine ions is preferable.

An amount of the above-mentioned photosensitive silver halide to be blended is preferably 0.0005 to 0.2 parts by weight per 100 parts by weight of the organic silver salt, more preferably 0.01 to 0.2 parts by weight.

The above-mentioned reducing agent is not particularly limited and appropriately selected depending on the silver salt used in combination, and substituted phenols, bisphenols, naphthols, bisnaphthols, polyhydroxybenzens, di- or poly-hydroxynaphthalenes, hydroquinone monoethers, ascorbic acid or derivatives thereof, reducing saccharides, aromatic amino compounds, hydroxylamines, hydrazines, phenidones, hydroquinones and hindered phenols are given, and they include photodegradable reducing agents and thermally decomposing reducing agents. Among them, photodegradable reducing agents are preferable and hindered phenols are particularly preferable.

An amount of the above-mentioned reducing agent to be blended is preferably 0.0001 to 3.0 parts by weight per 100 parts by weight of the organic silver salt, more preferably 0.01 to 1.0 parts by weight.

A compound, which promotes photodegradation, may be used in conjunction with the above-mentioned reducing agent and a covering agent for inhibiting a reaction of the reducing agent with silver halide may be used similarly.

As a method of producing the thermal developing photosensitive material of the sixth present invention, there is given, for example, a method in which the modified vinyl acetal resin of the first present invention or the second present invention, an organic silver salt, a reducing agent and a solvent are dispersed by a ball mill and then silver halide or a silver halide forming component and various additives are further added to the solution as required and the mixture is dispersed with a ball mill, and the resulting dispersion is applied onto a supporting member in such a way that an amount of organic silver salt becomes a specified level and a solvent is evaporated. Further, the above organic silver and the above reducing agent may be blended in the modified vinyl acetal resin of the first present invention or the second present invention by one operation and the mixture may be applied to a supporting member to form a layer or the above organic silver and the above reducing agent may be separately blended in two modified vinyl acetal resins of the first present invention or the second present invention and these different mixtures may be separately applied to a supporting member to form two layers.

As the above-mentioned solvent, there are favorably used substances which can dissolve the modified vinyl acetal resin of the first present invention or the second present invention and hardly contain water. Particularly, ketones and esters are preferable, and diethyl ketone, methyl ethyl ketone, methyl-iso-butyl ketone, methyl acetate, ethyl acetate, propyl acetate and the like are more preferable.

As the above-mentioned supporting member, resin films such as polyethylene terephthalate, polycarbonate, polyethylene, polypropylene, polyvinylacetal, cellulose ester, cellulose diacetate, cellulose triacetate, nitrocellulose, polyethylene naphthalate, vinyl chloride and chlorinated polypropylene; glass; paper; metal plates such as an aluminum plate are used.

An amount of silver to be applies to the above supporting member is preferably 0.1 to 5.0 g per 1 m² of the supporting member. When this amount is less than 0.1 g, image density may become low, and when it is more than 5.0 g, enhancement of image density will not be recognized. It is more preferably 0.3 to 3.0 g per 1 m². In addition, the organic silver may be applied to one side of the supporting member or both sides thereof.

The thermal developing photosensitive material of the sixth present invention can be stored for long periods without a problem of blocking, and can inhibit the deterioration of a storage stability of a raw film resulting from absorption of moisture and the occurrence of fog, and has a excellent storage stability of films after forming images and exhibits excellent image characteristics by keeping the balance of hydrophilicity.

The seventh present invention is a slurry composition for a ceramic green sheet, which contains the modified vinyl acetal resin of the first present invention or the second present invention, ceramic powder, a plasticizer and an organic solvent.

An acetalization degree of the modified polyvinyl acetal resin of the first present invention or the second present invention in the case of being used in the slurry composition for a ceramic green sheet of the seventh present invention is more preferably 40 to 79 mole % whether the acetalization is performed by a kind of aldehyde or by a mixture of two or more kinds of aldehydes. When the acetalization degree is less than 40 mole %, the modified polyvinyl acetal resin of the first present invention or the second present invention becomes soluble in water and insoluble in an organic solvent. When it is more than 79 mole %, number of residual hydroxyl groups becomes less and the toughness of the modified polyvinyl acetal resin of the first present invention or the second present invention may be impaired and the strength of the ceramic green sheet may be deteriorated.

An polymerization degree of the modified polyvinyl acetal resin of the first present invention or the second present invention in the case of being used in the slurry composition for a ceramic green sheet of the seventh present invention is not particularly limited but it is more preferably 300 to 2,400. When the polymerization degree is less than 300, the strength of a ceramic green sheet formed from a slurry composition is low and the ceramic green sheet is apt to generate breaks and cracks in being released from a supporting member, and when it is more than 2,400, since the solution viscosity of the slurry becomes too high, the slurry is poor in dispersibility and homogeneous slurry cannot be attained.

An amount of the modified polyvinyl acetal resin of the first present invention or the second present invention to be blended is preferably 3 to 15 weight % with respect to the total amount of the slurry composition for a ceramic green sheet of the seventh present invention. When the amount of the modified polyvinyl acetal resin to be blended is less than 3 weight %, because an amount of the modified polyvinyl acetal resin of the first present invention or the second present invention dispersed throughout ceramic powder is insufficient, flexibility of the ceramic green sheet to be obtained is insufficient and cracks may occur after sintering. When it is more than 15 weight %, the slurry composition for a ceramic green sheet of the seventh present invention becomes too high in viscosity and therefore the dispersibility thereof is deteriorated, or shrinkage of the sheet becomes large in sintering the obtained ceramic green sheet.

The above-mentioned ceramic powder is not particularly limited and ceramic powder conventionally used for producing a ceramic green sheet is given. As such ceramic powder, there is given powder composed of, for example, alumina, zirconia, aluminum silicate, titanium oxide, zinc oxide, barium titanate, magnesia, sialon, spinel mullite, crystallized glass, silicon carbide, silicon nitride, aluminum nitride or the like. These ceramic powders may be used alone or in combination of two or more species.

And glass frit such as MgO—SiO₂—CaO system, B₂O₃—SiO₂ system, PbO—B₂O₃—SiO₂ system, CaO—SiO₂—MgO—B₂O₃ system or PbO—SiO₂—B₂O₃—CaO system may be added to these ceramic powders.

A particle size of the above-mentioned ceramic powder is preferably fine, and ceramic powder having a particularly fine particle size is preferably used for attaining a thin ceramic green sheet. For example, it is preferred that the above-mentioned ceramic powder has a particle size of 0.3 μm or smaller in order to attain a ceramic green sheet of 3 μm or less in thickness.

An amount of the above-mentioned ceramic powder to be blended is preferably 30 to 80 weight % with respect to the total amount of the slurry composition for a ceramic green sheet of the seventh present invention. When the amount to be blended is less than 30 weight %, handling in forming the ceramic green sheet may deteriorate since the viscosity of the slurry composition for a ceramic green sheet of the seventh present invention becomes too low. When it is more than 80 weight %, a kneading property may be deteriorated since the viscosity of the slurry composition for a ceramic green sheet of the seventh present invention becomes too high.

The above-mentioned plasticizer is not particularly limited, and any plasticizer can be employed as long as it is high in compatibility with the modified polyvinyl acetal resin of the first present invention or the second present invention. As the plasticizer, there are given phthalates such as dibutyl phthalate, dioctyl phthalate, diisodecyl phthalate, butyl benzyl phthalate, etc.; phosphates such as tricresylphosphate, tributyl phosphate, triethyl phosphate, etc.; fatty acid esters such as methylacetyl ricinoleate, dibutyl sebacate and dioctyl adipate, etc.; glycol derivatives such as butylphthalyl glycolate, triethylene glycol-2-ethyl butylate, etc. These plasticizers may be used alone or in combination of two or more species.

An amount of the above plasticizer to be blended is preferably 0.1 to 10 weight % with respect to the total amount of the slurry composition for a ceramic green sheet of the seventh present invention. When the amount to be blended is less than 0.1 weight %, the flexibility of the ceramic green sheet, which is obtained by blending the plasticizer, will be insufficient. When it is more than 10 weight %, handling in forming the ceramic green sheet may be deteriorated since the ceramic green sheet becomes too flexible.

The above-mentioned organic solvent is not particularly limited and ketones such as acetone, methyl ethyl ketone, etc.; alcohols such as methanol, ethanol, isopropanol, n-propanol, n-butanol, etc.; and aromatic hydrocarbons such as toluene, xylene, etc. are given. These solvents may be used alone or in combination of two or more species.

An amount of the above-mentioned solvent to be blended is preferably 20 to 80 weight % with respect to the total amount of the slurry composition for a ceramic green sheet of the seventh present invention. When the amount to be blended falls within this range, it is possible to dissolve the modified polyvinyl acetal resin of the first present invention or the second present invention and to provides the slurry composition for a ceramic green sheet of the seventh present invention with an adequate kneading property.

The slurry composition for a ceramic green sheet of the seventh present invention may include a lubricant, a dispersant, a deflocculant, a wetting agent, an antistatic agent, an antifoaming agent, etc. as required within the bounds of being able to attain an object of the seventh present invention.

The slurry composition for a ceramic green sheet of the seventh present invention can be prepared by blending the modified polyvinyl acetal resin of the first present invention or the second present invention, a ceramic powder, a plasticizer and an organic solvent and mixing them by an ordinary technique.

The ceramic green sheet can be obtained by configuring the slurry composition for a ceramic green sheet of the seventh present invention in sheet form and drying it. For example, after the slurry composition for a ceramic green sheet of the seventh present invention is deaerated as required, it is applied onto the surface of a supporting member such as a polyester film or a stainless steel plate from which the ceramic green sheet is removable, and after removing an organic solvent by heating and drying, it is released from the supporting member. Such a ceramic green sheet formed by using the slurry composition for a ceramic green sheet of the seventh present invention is also one of the present inventions.

By using the ceramic green sheet of the present invention, a laminated ceramic condenser can be attained. It is possible to obtain the above-mentioned laminated ceramic condenser by superposing two or more sheets of processed ceramic green sheets which is formed by applying a conductive paste to become an internal electrode by screen process printing onto the ceramic green sheet of the present invention, thermally attaching the processed ceramic green sheet to another by pressure to prepare a laminate, cutting the laminate to the predetermined shape and dimensions, and then heating the cut laminate to elevated temperatures of, for example, about 600° C. to decompose the polyvinyl acetal resin, used as a binder resin, of the first present invention or the second present invention thoroughly, and further heating it to elevated temperatures of, for example, about 1350° C. to sinter the ceramic powder and subsequently sintering an external electrode on the side of the resulting ceramic sintered body.

The slurry composition for a ceramic green sheet of the seventh present invention contains the polyvinyl acetal resin of the first present invention or the second present invention as a binder resin and since the hydrogen bond strength of the modified polyvinyl acetal resin is weakened in terms of steric hindrance, it has low viscosity and excellent secular stability of viscosity compare with the case where only a unmodified polyvinyl acetal resin is used as a binder resin. This allows the slurry composition to become higher solid contents by reducing an amount of a solvent to be used and also the slurry to be stored for long periods.

The ceramic green sheet of the present invention substantially improves in sheet strength, particularly ductility, since the slurry composition for a ceramic green sheet of the seventh present invention need not contain a plasticizer excessively, and has a good balanced adhesive property in lamination in which the ceramic green sheet is easy to be released from a supporting member and has a high adhesive property in being attached to another by pressure. Because the ceramic green sheet of the present invention has low moisture absorption, it can be stored in a state of a ceramic green sheet for long periods and is less subject to moisture when it is subjected to process such as punching. Therefore, it can be formed without being affected by moisture and laminated without being damaged even when it is a thin layer ceramic green sheet having a thickness of 3 μm or smaller. Further, in the ceramic green sheet of the present invention, since the contained polyvinyl acetal resin of the first present invention or the second present invention is excellent in a thermal decomposition property and very low in a thermal decomposition residue, it does not produce the thermal decomposition residue of the binder in the ceramic green sheet after sintering even when a laminate, formed by superposing a thin layer ceramic green sheet having a thickness of 3 μm or smaller by 500 sheets or more, is sintered and therefore it can attain a laminate superior in electrical characteristics. Accordingly, it is possible to respond to downsizing of electronic devices such as a laminated ceramic condenser and also to respond to LTCC (low temperature cofired ceramic substrate) which requires a debinder property at low temperature such as uses of glass powder and uses of copper in an electrode. And, since the modified polyvinyl acetal resin of the first present invention or the second present invention contains ethylene units as a monomer unit, the ceramic green sheet of the present invention improves in compatibility with a plasticizer remarkably and therefore suppresses bleeding of the plasticizer and allows the ceramic green sheet to be stored for long periods, and further since it shows a small shrinkage rate in sintering, it improves in dimensional stability and can respond to downsizing of electronic devices.

### BEST MODE FOR CARRYING OUT THE INVENTION

Hereinafter, the present invention will be described in more detail by way of examples, but the present invention is not limited to these examples.

### EXAMPLE 1

<Preparation of Modified Polyvinyl Acetal Resin>

193 g of modified polyvinyl alcohol, which has a polymerization degree of 800, an ethylene content of 5 mole % and a saponification degree of 93 mole %, having ethylene in a random basis as a constituent unit of a main chain was added to 2,900 g of pure water and the mixture was stirred at a temperature of 90° C. for about 2 hours and dissolved. This solution was cooled to 28° C. and 20 g of 35 weight % hydrochloric acid and 115 g of n-butyl aldehyde were added to the solution and a temperature of the mixture was lowered to 20° C. and kept at this temperature to acetalize it and precipitate a reaction product. Then, a liquid temperature was kept at 30° C. for 5 hours to complete an acetalization reaction. The mixture of a reaction product was neutralized, water-washed and dried by a normal method to obtain white powder of a modified polyvinyl acetal resin.

The resulting modified polyvinyl acetal resin was dissolved in DMSO-d₆ (dimethylsulfoxide) and a degree of acetalization was measured using ¹³C-NMR (Nuclear Magnetic Resonance Spectrum) spectrometer to obtain the acetalization degree of 68 mole %. And, it could be verified that the modified polyvinyl acetal resin had ethylene in a random basis as a constituent unit of a main chain because only one glass transition temperature appeared when the glass transition temperature was measured with a differential scanning calorimeter and the modified polyvinyl acetal resin was dissolved thoroughly in a mixed solution of ethanol and toluene having a weight ratio of 1:1 and in methyl ethyl ketone.

### EXAMPLES 2 to 4

Modified polyvinyl acetal resins were obtained by following the same procedure as Example 1 except for changing a polymerization degree, an ethylene content, a saponification degree, a kind of aldehyde and an acetalization degree of polyvinyl alcohol as shown in Table 1. In addition, in Example 4, a mixture of modified polyvinyl alcohol and unmodified polyvinyl alcohol having a weight ratio of 1:1 was used. It could be verified that the resulting modified polyvinyl acetal resins had ethylene in a random basis as a constituent unit of a main chain because only one glass transition temperature, which corresponded to one kind of modified polyvinyl acetal contained, appeared when the glass transition temperature of modified polyvinyl acetal resin was measured with a differential scanning calorimeter and the modified polyvinyl acetal resin was dissolved thoroughly in a mixed solution of ethanol and toluene having a weight ratio of 1:1 and in methyl ethyl ketone.

### COMPARATIVE EXAMPLES 1 TO 4

Polyvinyl acetal resins having approximately the same acetalization degree as corresponding Examples 1 to 4 were obtained by following the same procedures as corresponding Examples 1 to 4 except for using unmodified polyvinyl alcohol having the same structure as modified polyvinyl alcohol used in Examples 1 to 4 other than not containing ethylene as a monomer unit.

TABLE 1

| | Polyvinyl alcohol | | | Polyvinyl acetal resin | |
|---|---|---|---|---|---|
| | | Ethylene | Saponification | | Acetalization |
| | Polymerization | content | degree | | degree |
| | degree | (mole %) | (mole %) | Aldehyde | (mole %) |
| Example 1 | 800 | 5 | 93 | n-butyl aldehyde | 72 |
| Example 2 | 500 | 10 | 88 | n-butyl aldehyde | 68 |
| Example 3 | 800 | 10 | 88 | Acetaldehyde | 71 |
| Example 4 | 800 | 5 | 93 | n-butyl aldehyde | 69 |
| | 800 | 0 | 98 | | |
| Comparative | 800 | 0 | 93 | n-butyl aldehyde | 72 |
| Example 1 | | | | | |
| Comparative | 500 | 0 | 88 | n-butyl aldehyde | 68 |
| Example 2 | | | | | |
| Comparative | 800 | 0 | 88 | Acetaldehyde | 72 |
| Example 3 | | | | | |
| Comparative | 800 | 0 | 93 | n-butyl aldehyde | 70 |
| Example 4 | 800 | 0 | 88 | | |

<Performance Evaluations>

Oxygen transmission coefficients and thermal decomposition properties of the polyvinyl acetal resins obtained in Examples 1 to 4 and Comparative Examples 1 to 4 were evaluated according to the following methods and the results of evaluations were shown in Tables 2 and 3.

(Measurement of an Oxygen Transmission Coefficient)

The polyvinyl acetal resin was added to a mixed solution of ethanol and toluene having a weight ratio of 1:1 and dissolved in such a way that the concentration of resin is 15 weight %. Then, this solution was applied to a polyethylene terephthalate (hereinafter, also referred to as PET) film and dried at 50° C. for 6 hours to obtain a polyvinyl acetal film having a thickness of 50 μm. Next, this polyvinyl acetal film was dried in a vacuum at room temperature for 6 days and subjected to measurement. Measurement was conducted using a differential pressure type Gas Permeability Rate Analyzer System and an oxygen gas as a test gas and an oxygen transmission coefficient was determined in conditions of a test gas pressure of 15 N/cm², a test temperature of 25° C. and a gas transmission area of 15.2 cm².

(Measurement of a Thermal Decomposition Property)

Measurement of Tg/DTA was conducted in conditions of a measuring temperature range of 30° C. to 700° C. and a rate of a temperature rise of 10° C./minute and in atmospheres of air flow and nitrogen flow, having flow rates of 200 ml/minute, respectively, using a platinum pan in a state of being open as a test container.

TABLE 2

| | Oxygen transmission coefficient |
|---|---|
| | (cc · cm/cm² · sec · cmHg) |
| Example 1 | 5.22 × 10⁻¹¹ |
| Example 2 | 4.43 × 10⁻¹¹ |
| Example 3 | 4.12 × 10⁻¹¹ |
| Example 4 | 7.35 × 10⁻¹¹ |
| Comparative Example 1 | 9.50 × 10⁻¹¹ |
| Comparative Example 2 | 9.89 × 10⁻¹¹ |
| Comparative Example 3 | 9.68 × 10⁻¹¹ |
| Comparative Example 4 | 9.21 × 10⁻¹¹ |

TABLE 3

Rate of change of weight
with respect to weight
at 30° C.(weight %)

| | 100° C. | 300° C. | 500° C. | 700° C. |
|---|---|---|---|---|
| Example 1 | −0.4 | −0.5 | −98.8 | −99.9 |
| Example 2 | −0.2 | −0.3 | −98.4 | −99.1 |
| Example 3 | −0.3 | −0.5 | −98.8 | −99.9 |
| Example 4 | −0.1 | −0.2 | −95.8 | −96.1 |
| Comparative | 0 | 0 | −93.2 | −94.4 |
| Example 1 | | | | |
| Comparative | −0.1 | −0.2 | −92.0 | −93.0 |
| Example 2 | | | | |
| Comparative | −0.2 | −0.4 | −92.3 | −94.0 |
| Example 3 | | | | |
| Comparative | 0 | −0.4 | −94.9 | −95.5 |
| Example 4 | | | | |

From the results of Table 2, it is shown that the polyvinyl acetal resins obtained in Examples 1 to 4 have lower values of an oxygen transmission coefficient than the polyvinyl acetal resins obtained in Comparative Examples 1 to 4 and they are less permeable to oxygen. That is, it is understood that the modified polyvinyl acetal resin exhibits a greater improvement in a gas barrier property than the unmodified polyvinyl acetal resin.

From the results of Table 3, it is shown that with respect to a thermal decomposition property, the polyvinyl acetal resins obtained in Examples 1 to 4 were thermally decomposed almost thoroughly at 700° C., referring to rates of change of weight. On the other hand, the polyvinyl acetal resins obtained in Comparative Examples 1 to 4 had low rates of change of weight compared with the polyvinyl acetal resins obtained in Examples 1 to 4. That is, it is understood that the modified polyvinyl acetal resin exhibits a greater improvement in a thermal decomposition property than the unmodified polyvinyl acetal resin.

### EXAMPLES 5 to 11

Modified polyvinyl acetal resins were obtained by following the same procedure as Example 1 except for changing a polymerization degree, an ethylene content, a saponification degree, a kind of aldehyde and an acetalization degree of polyvinyl alcohol as shown in Table 4. In addition, in Examples 9 to 11, mixtures of modified polyvinyl alcohol and unmodified polyvinyl alcohol having a weight ratio of 1:1 were used. It could be verified that the resulting modified polyvinyl acetal resins had ethylene in a random basis as a constituent unit of a main chain because only one glass transition temperature, which corresponded to one kind of modified polyvinyl acetal contained, appeared when the glass transition temperature of modified polyvinyl acetal resin was measured with a differential scanning calorimeter and the modified polyvinyl acetal resin was dissolved thoroughly in a mixed solution of ethanol and toluene having a weight ratio of 1:1 and in methyl ethyl ketone.

### COMPARATIVE EXAMPLES 5 to 11

Polyvinyl acetal resins having the same acetalization degree as corresponding Examples 5 to 11 were obtained by following the same procedures as corresponding Examples 5 to 11 except for using unmodified polyvinyl alcohol having the same structure as modified polyvinyl alcohol used in Examples 5 to 11 other than not containing ethylene as a monomer unit.

<Performance Evaluations>

Performances of the polyvinyl acetal resins obtained in Examples 5 to 11 and Comparative Examples 5 to 11 such as solution viscosity, secular stability of the solution viscosity (a rate of change of viscosity) and ductility of a coat were evaluated according to the following methods and the results of evaluations were shown in Tables 4 and 5.

(Solution Viscosity and Difference in Viscosity)

The polyvinyl acetal resins obtained in Examples 5 to 11 and Comparative Examples 5 to 11 were added to a mixed solution of ethanol and toluene having a weight ratio of 1:1 and dissolved thoroughly in such a way that the concentration of resin is 10 weight %. Then, the viscosity of this solution was measured at 20° C. using a Brookfield type rotational viscometer (initial viscosity).

Next, the solution viscosity of the modified polyvinyl acetal resin obtained in Example 5 was compared with the solution viscosity of the unmodified polyvinyl acetal resin obtained in Comparative Example 5 corresponding to Example 5, and (a rate of) a difference in viscosity was determined from the following formula (3).

Difference in viscosity (%)=(A−B)/B×100 (3)

In the formula (3), A represents the viscosity of the modified polyvinyl acetal resin (Example 5) and B represents the viscosity of the unmodified polyvinyl acetal resin (Comparative Example 5).

Similarly, the solution viscosities of the modified polyvinyl acetal resins obtained in Examples 6 to 11 were compared with the solution viscosities of the unmodified polyvinyl acetal resins obtained in Comparative Examples 6 to 11 corresponding to Examples 6 to 11, respectively, and a difference in viscosity was determined.

(Secular Stability of Solution Viscosity (Rate of Change of Viscosity))

The solution of which the initial viscosity was measured was stored for 1 month in a thermostatic chamber kept at 20° C., and the viscosity after the storage was measured at 20° C. using a Brookfield type rotational viscometer, and a rate of change of viscosity was determined from the following formula (4).

Rate of change of viscosity (%)=(C−D)/D×100 (4)

In the formula (4), C represents the viscosity of 1 month later and D represents the initial viscosity.

(Ductility of a Coat and Difference in Ductility)

By using the polyvinyl acetal resins obtained in Examples 5 to 11 and Comparative Examples 5 to 11, films having a thickness of 50 μm were prepared by casting. This film was stretched at a stretch speed of 10 mm/minute and a ductility of a maximum point at 20° C. was measured using Autograph (manufactured by SHIMADZU CORPORATION).

Next, the ductility of a maximum point of the modified polyvinyl acetal resin obtained in Example 5 was compared with the ductility of a maximum point of the unmodified polyvinyl acetal resin obtained in Comparative Example 5 corresponding to Example 5, and (a rate of) a difference in ductility was determined from the following formula (5).

Difference in ductility (%)=(E−F)/F×100 (5)

In the formula (5), E represents the ductility of a maximum point of the modified polyvinyl acetal resin (Example 5) and F represents the ductility of a maximum point of the unmodified polyvinyl acetal resin

### COMPARATIVE EXAMPLE 5

Similarly, the ductility of a maximum point of the modified polyvinyl acetal resins obtained in Examples 6 to 11 were compared with the ductility of a maximum point of the unmodified polyvinyl acetal resins obtained in Comparative Examples 6 to 11 corresponding to Examples 6 to 11, respectively, and (a rate of) a difference in ductility was determined.

TABLE 4

| | | Polyvinyl alcohol | | | | Polyvinyl acetal resin | Results of performance evaluation | | |
|---|---|---|---|---|---|---|---|---|---|
| | | Polymeri- | Ethylene | Saponification | PVA | Aldehyde | Difference | Rate of change | Difference |
| | | zation | content | degree | blending | (acetalization | in viscosity | of viscosity | in ductility |
| | | degree | (mole %) | (mole %) | ratio | degree: mole %) | (%) | (%) | (%) |
| Example | 5 | 800 | 5 | 93 | — | n-butyl aldehyde (68) | −62 | +1 | +75 |
| | 6 | 800 | 10 | 88 | — | n-butyl aldehyde (60) | −58 | +3 | +68 |
| | 7 | 800 | 5 | 93 | — | n-butyl aldehyde (28) | −57 | +6 | +61 |
| | | | | | | Acetaldehyde (34) | | | |
| | 8 | 800 | 10 | 88 | — | Acetaldehyde (65) | −59 | +8 | +55 |
| | 9 | 300 | 5 | 93 | 1/1 | n-butyl aldehyde (68) | −61 | +2 | +63 |
| | | 300 | 0 | 98 | Weight ratio | | | | |
| | 10 | 300 | 5 | 93 | 1/1 | n-butyl aldehyde (30) | −59 | +5 | +58 |
| | | 300 | 0 | 98 | Weight ratio | Acetaldehyde (36) | | | |
| | 11 | 300 | 5 | 93 | 1/1 | Acetaldehyde (70) | −57 | +9 | +52 |
| | | 300 | 0 | 98 | Weight ratio | | | | |

TABLE 5

| | | | | | | | Results of |
|---|---|---|---|---|---|---|---|
| | | | | | | | performance |
| | | Polyvinyl alcohol | | | | | evaluation |
| | | | Ethylene | Saponification | | Polyvinyl acetal resin | Rate of change |
| | | Polymerization | content | degree | PVA | Aldehyde (acetalization | of viscosity |
| | | degree | (mole %) | (mole %) | blending ratio | degree: mole %) | (%) |
| Comparative | 5 | 800 | 0 | 93 | — | n-butyl aldehyde (68) | +32 |
| Example | 6 | 800 | 0 | 88 | — | n-butyl aldehyde (60) | +43 |
| | 7 | 800 | 0 | 93 | — | n-butyl aldehyde (28) | +57 |
| | | | | | | Acetaldehyde (34) | |
| | 8 | 800 | 0 | 88 | — | Acetaldehyde (65) | +74 |
| | 9 | 300 | 0 | 93 | 1/1 | n-butyl aldehyde (68) | +39 |
| | | 300 | 0 | 98 | Weight ratio | | |
| | 10 | 300 | 0 | 93 | 1/1 | n-butyl aldehyde (30) | +63 |
| | | 300 | 0 | 98 | Weight ratio | Acetaldehyde (36) | |
| | 11 | 300 | 0 | 93 | 1/1 | Acetaldehyde (70) | +82 |
| | | 300 | 0 | 98 | Weight ratio | | |

The results of Tables 4 and 5 show that the unmodified polyvinyl acetal resins obtained in Comparative Examples 5 to 11 significantly increased in the rate of change of viscosity compared with the modified polyvinyl acetal resins obtained in Examples 5 to 11. That is, it is understood that the unmodified polyvinyl acetal resin exhibits a low stability of viscosity. Also, it is understood from a difference in viscosity that the modified polyvinyl acetal resins have a significantly lower solution viscosity than the unmodified polyvinyl acetal resins. Further, it is understood from a difference in ductility of a coat that the modified polyvinyl acetal resins have a significantly larger ductility than the unmodified polyvinyl acetal resins and are superior in flexibility.

### EXAMPLE 12

<Preparation of Modified Polyvinyl Acetal Resin>

193 g of modified polyvinyl alcohol, which has a polymerization degree of 2,000, an ethylene content of 5 mole % and a saponification degree of 98 mole %, having ethylene in a random basis as a constituent unit of a main chain was added to 2,900 g of pure water and the mixture was stirred at a temperature of 90° C. for about 2 hours and dissolved. This solution was cooled to 28° C. and 20 g of 35 weight % hydrochloric acid was added to the solution and further 51 g of acetaldehyde was added. Then, the mixture was cooled to 12° C. and 48 g of n-butyl aldehyde was added to acetalize the mixture and precipitate a reaction product. Then, a liquid temperature was kept at 60° C. for 5 hours to complete an acetalization reaction and the mixture of a reaction product was neutralized, water-washed and dried by a normal method to obtain white powder of a modified polyvinyl acetal resin.

The resulting modified polyvinyl acetal resin was dissolved in DMSO-d₆ and a degree of acetalization was measured using ¹³C-NMR spectrometer. As a result, the degree of acetalization was 43 mole % and a degree of butyralization was 30 mole % and therefore total acetalization degree was 73 mole %. And, it could be verified that the modified polyvinyl acetal resin had ethylene in a random basis as a constituent unit of a main chain because only one glass transition temperature appeared when the glass transition temperature was measured with a differential scanning calorimeter and the modified polyvinyl acetal resin was dissolved thoroughly in a mixed solution of ethanol and toluene having a weight ratio of 1:1 and in methyl ethyl ketone.

<Preparation of Adhesive Composition>

40 g of the above-mentioned modified polyvinyl acetal resin, 62 g of phenolic resin (trademark: PL-2205, produced by Gunei Chemical Industry Co., Ltd.) and 4 g of epoxy resin (trademark: Epicoat 828, produced by Shell Oil CO., Ltd.) were dissolved in 258 g of mixed solvent of methanol, methyl ethyl ketone and toluene (weight ratio 2:2:1) to prepare a adhesive composition.

Next, the resulting adhesive composition was applied to copper foil for a printed circuit board in such a way that thickness of the adhesive composition as a solid matter is 33 μm, and dried at 140° C. for 4 minutes to obtain copper foil with an adhesive layer. This copper foil with an adhesive layer was left alone in conditions of 20° C. and 70% humidity for 3 days. Then, the above-mentioned copper foil with an adhesive layer and a phenol-impregnated paper were pressed and formed at 150° C. and at a pressure of 1200 N/cm² for 30 minutes to laminate a laminated plate of copper foil.

### EXAMPLES 13 TO 14, COMPARATIVE EXAMPLES 12 TO 13

Adhesive compositions were prepared by following the same procedure as Example 12 except for changing a polymerization degree, an ethylene content, a saponification degree, a kind of aldehyde and an acetalization degree of modified polyvinyl alcohol as shown in Table 6 and laminated plates of copper foil were laminated using the adhesive compositions. It could be verified that the modified polyvinyl acetal resins, obtained in Examples 13 and 14, had ethylene in a random basis as a constituent unit of a main chain because only one glass transition temperature, which corresponded to one kind of modified polyvinyl acetal contained, appeared when the glass transition temperature of modified polyvinyl acetal resin was measured with a differential scanning calorimeter and the modified polyvinyl acetal resin was dissolved thoroughly in a mixed solution of ethanol and toluene having a weight ratio of 1:1 and in methyl ethyl ketone.

### EXAMPLE 15

<Preparation of Adhesive Composition>

40 g of the modified polyvinyl acetal resin, prepared in Example 12, having ethylene in a random basis as a constituent unit of a main chain, 62 g of melamine resin (trademark: UVAN 22R produced by MITSUI CHEMICALS INC) and 4 g of epoxy resin (trademark: Epicoat 828, produced by Shell Oil CO., Ltd.) were dissolved in 258 g of mixed solvent of methanol, methyl ethyl ketone and toluene (weight ratio 2:2:1) to prepare a adhesive composition.

Next, the resulting adhesive composition was applied to copper foil for a printed circuit board in such a way that thickness of the adhesive composition as a solid matter is 33 μm, and dried at 140° C. for 4 minutes to obtain copper foil with an adhesive layer. This copper foil with an adhesive layer was left alone in conditions of 20° C. and 70% humidity for 3 days. Then, the above-mentioned copper foil with an adhesive layer and a phenol-impregnated paper were pressed and formed at 150° C. and at a pressure of 1200 N/cm² for 30 minutes to laminate a laminated plate of copper foil.

### EXAMPLES 16 TO 17, COMPARATIVE EXAMPLES 14 TO 15

Adhesive compositions were prepared by following the same procedure as Example 15 except for changing a polymerization degree, an ethylene content, a saponification degree, a kind of aldehyde and an acetalization degree of modified polyvinyl alcohol as shown in Table 6 and laminated plates of copper foil were laminated using the adhesive compositions.

### EXAMPLE 18

<Preparation of Adhesive Composition>

7 g of the modified polyvinyl acetal resin, prepared in Example 12, having ethylene in a random basis as a constituent unit of a main chain, 60 g of epoxy resin (trademark: Epicoat 828, produced by Shell Oil CO., Ltd.) and 5 g of melamine resin (trademark UVAN 22R produced by MITSUI CHEMICALS INC) were dissolved in 258 g of mixed solvent of methanol, methyl ethyl ketone and toluene (weight ratio 2:2:1) to prepare a adhesive composition.

Next, the resulting adhesive composition was applied to copper foil for a printed circuit board in such a way that thickness of the adhesive composition as a solid matter is 33 μm, and dried at 140° C. for 4 minutes to obtain copper foil with an adhesive layer. This copper foil with an adhesive layer was left alone in conditions of 20° C. and 70% humidity for 3 days.

Then, the above-mentioned copper foil with an adhesive layer and a prepreg formed by impregnating a glass cloth with an epoxy resin were pressed and formed at 150° C. and at a pressure of 1200 N/cm² for 30 minutes to laminate a laminated plate of copper foil.

### EXAMPLES 19 TO 20, COMPARATIVE EXAMPLES 16 TO 17

Adhesive compositions were prepared by following the same procedure as Example 15 except for changing a polymerization degree, an ethylene content, a saponification degree, a kind of aldehyde and an acetalization degree of modified polyvinyl alcohol as shown in Table 6 and laminated plates of copper foil were laminated using the adhesive compositions.

<Performance Evaluations>

Solder heat resistance and peel strength were measured on laminated plates of copper foil obtained in Examples 12 to 20 and Comparative Examples 12 to 17 according to JIS C 6485. Here, testing temperatures were 260° C. in a solder heat resistance test and 150° C. in a peel strength test. The results are shown in Table 6.

TABLE 6

| | | | | | | | | Results of performance | |
|---|---|---|---|---|---|---|---|---|---|
| | | Polyvinyl alcohol | | | | | | evaluation | |
| | | | Ethylene | Saponification | PVA | Polyvinyl acetal resin | Thermosetting | | Peel |
| | | Polymerization | content | degree | blending | Aldehyde (acetalization | resin | Solder heat | strength |
| | | degree | (mole %) | (mole %) | ratio | degree: mole %) | Kind | resistance (sec) | (N/cm) |
| Example | 12 | 2000 | 5 | 98 | — | n-butyl aldehyde (30) | Phenolic resin & | 37 | 5.7 |
| | | | | | | Acetaldehyde (43) | Epoxy resin | | |
| | 13 | 2400 | 10 | 98 | — | Acetaldehyde (73) | Phenolic resin & | 35 | 5.8 |
| | | | | | | | Epoxy resin | | |
| | 14 | 2000 | 5 | 98 | 1/1 | n-butyl aldehyde (3) | Phenolic resin & | 36 | 6.1 |
| | | 3500 | 5 | 98 | Weight | Acetaldehyde (71) | Epoxy resin | | |
| | | | | | ratio | | | | |
| | 15 | 2000 | 5 | 98 | — | n-butyl aldehyde (30) | Melamine resin & | 37 | 5.5 |
| | | | | | | Acetaldehyde (43) | Epoxy resin | | |
| | 16 | 2400 | 10 | 98 | — | Acetaldehyde (73) | Melamine resin & | 39 | 5.7 |
| | | | | | | | Epoxy resin | | |
| | 17 | 2000 | 5 | 98 | 1/1 | n-butyl aldehyde (3) | Melamine resin & | 41 | 6.3 |
| | | 3500 | 5 | 98 | Weight | Acetaldehyde (71) | Epoxy resin | | |
| | | | | | ratio | | | | |
| | 18 | 2000 | 5 | 98 | — | n-butyl aldehyde (30) | Epoxy resin & | 58 | 7.7 |
| | | | | | | Acetaldehyde (43) | Melamine resin | | |
| | 19 | 2400 | 10 | 98 | — | Acetaldehyde (73) | Epoxy resin & | 63 | 8.1 |
| | | | | | | | Melamine resin | | |
| | 20 | 2000 | 5 | 98 | 1/1 | n-butyl aldehyde (3) | Epoxy resin & | 66 | 8.5 |
| | | 3500 | 5 | 98 | Weight | Acetaldehyde (71) | Melamine resin | | |
| | | | | | ratio | | | | |
| Comparative | 12 | 2000 | 0 | 98 | — | n-butyl aldehyde (30) | Phenolic resin & | 23 | 2.6 |
| Example | | | | | | Acetaldehyde (43) | Epoxy resin | | |
| | 13 | 2400 | 0 | 98 | — | Acetaldehyde (73) | Phenolic resin & | 25 | 2.8 |
| | | | | | | | Epoxy resin | | |
| | 14 | 2400 | 0 | 98 | — | Acetaldehyde (73) | Melamine resin & | 22 | 3.1 |
| | | | | | | | Epoxy resin | | |
| | 15 | 2000 | 0 | 98 | 1/1 | n-butyl aldehyde (3) | Melamine resin & | 23 | 2.9 |
| | | 3500 | | 98 | Weight | Acetaldehyde (71) | Epoxy resin | | |
| | | | | | ratio | | | | |
| | 16 | 2000 | 0 | 98 | — | n-butyl aldehyde (30) | Epoxy resin & | 26 | 3.7 |
| | | | | | | Acetaldehyde (43) | Melamine resin | | |
| | 17 | 2400 | 0 | 98 | — | Acetaldehyde (73) | Epoxy resin & | 27 | 3.9 |
| | | | | | | | Melamine resin | | |

The results of Table 6 show that the laminated plates of copper foil obtained in Examples 12 to 20 were significantly high in both of the solder heat resistance and the peel strength compared with the laminated plates of copper foil obtained in Comparative Examples 12 to 17.

### EXAMPLE 21

<Preparation of Modified Polyvinyl Acetal Resin>

193 g of modified polyvinyl alcohol, which has a polymerization degree of 300, an ethylene content of 5 mole % and a saponification degree of 98 mole %, having ethylene in a random basis as a constituent unit of a main chain was added to 2,900 g of pure water and the mixture was stirred at a temperature of 90° C. for about 2 hours and dissolved. This solution was cooled to 28° C. and 20 g of 35 weight % hydrochloric acid and 115 g of n-butyl aldehyde were added to the solution and a temperature of the mixture was lowered to 20° C. and kept at this temperature to acetalize it and precipitate a reaction product. Then, a liquid temperature was kept at 30° C. for 5 hours to complete an acetalization reaction. The mixture of a reaction product was neutralized, water-washed and dried by a normal method to obtain white powder of a modified polyvinyl acetal resin.

The resulting modified polyvinyl acetal resin was dissolved in DMSO-d₆ and a degree of acetalization was measured using ¹³C-NMR spectrometer to obtain the acetalization degree of 68 mole %. And, it could be verified that the modified polyvinyl acetal resin had ethylene in a random basis as a constituent unit of a main chain because only one glass transition temperature appeared when the glass transition temperature was measured with a differential scanning calorimeter and the modified polyvinyl acetal resin was dissolved thoroughly in a mixed solution of ethanol and toluene having a weight ratio of 1:1 and in methyl ethyl ketone.

<Preparation of Ink>

4.4 g of the above-mentioned modified polyvinyl acetal resin and 25.6 g of ethanol were put in a glass bottle and stirred for 24 hours, and then 10 g of a pigment and glass beads were charged in the solution and a pigment was dispersed by shaking the bottle for 90 minutes with Paint Shaker (manufactured by Red Devil Company). Next, 8.5 g of ethyl acetate was additionally charged and further a small amount of additive was charged in the solution, and the mixture was shaked for 60 minutes to prepare ink. Here, the glass beads were charged in an amount of one-and-half times total weight of the modified polyvinyl acetal resin, ethanol and ethyl acetate.

### EXAMPLES 22 TO 27, COMPARATIVE EXAMPLES 18 TO 24

Inks were prepared by following the same procedure as Example 21 except for changing a polymerization degree, an ethylene content, a saponification degree, a kind of aldehyde and an acetalization degree of modified polyvinyl alcohol as shown in Table 7. It could be verified that the modified polyvinyl acetal resins, obtained in Examples 22 to 27, had ethylene in a random basis as a constituent unit of a main chain because only one glass transition temperature, which corresponded to one kind of modified polyvinyl acetal contained, appeared when the glass transition temperature of modified polyvinyl acetal resin was measured with a differential scanning calorimeter and the modified polyvinyl acetal resin was dissolved thoroughly in a mixed solution of ethanol and toluene having a weight ratio of 1:1 and in methyl ethyl ketone.

<Performance Evaluations>

The secular viscosity, the adhesion to a substrate and the oxygen transmittance of inks obtained in Examples 21 to 27 and Comparative Examples 18 to 24 were evaluated according to the following methods and the results of evaluations were shown in Table 7.

(Measurement of Secular Viscosity of Ink)

The viscosity (mPa·s) of ink at a shear rate of 1000 s⁻¹ and a measuring temperature of 25° C. was measured using a Mechanical Spectrometer (“RMS-800” manufactured by Rheometric Scientific, Inc). As a geometry of a viscometer, a biaxial cylindrical type was used. Samples were inserted into the biaxial cylindrical vessel by the required amount with a pipet and left alone for 5 minutes with pre-shear being applied, and then measured. Subsequently, the respective steady shear rate was applied to the sample. First, the steady shear rate was applied from a low-speed side (1 s⁻¹) to a high-speed side (1000 s⁻¹), and then the shear rate was applied from a high-speed side to a low-speed side. With respect to the viscosity behavior, the viscosity at the shear rate of 1000 s⁻¹ after application of a high-speed shear rate was taken as a viscosity value (A).

As an acceleration test replicating the ink condition in six months later, after the ink was left alone at 40° C. for 72 hours, the viscosity of the ink was measured by the method similar to the above-mentioned method and taken as a viscosity value (B).

The rate of change of ink viscosity (viscosity ratio) was determined from the above-mentioned viscosity value (A) and the above-mentioned viscosity value (B).

(Measurement of Adhesion to Substrate)

Ink was applied onto a polypropylene film having a thickness of 30 μm with a barcoater to form an ink layer having a thickness of 3 μm and then left alone in conditions of 20° C. and 90% humidity for 3 days. After the duration of being left alone, a cellophane adhesive tape was attached to the applied surface and then peeled off, and the amount of the remaining ink not peeled off from the film was visually observed and rated on the following scale of 3 levels.

◯: the ink layer remained fully on the film after peeling of a cellophane adhesive tape.

Δ: a part of the ink layer adhered to a cellophane adhesive tape peeled.

X: most of the ink layer adhered to a cellophane adhesive tape peeled.

(Measurement of an Oxygen Transmission Coefficient)

The ink was applied to a PET film and dried at 50° C. for 6 hours to obtain an ink film having a thickness of 50 μm. Next, this ink film was dried in a vacuum at room temperature for 6 days and subjected to measurement. Measurement was conducted using a differential pressure type Gas Permeability Rate Analyzer System and an oxygen gas as a test gas, and an oxygen transmission coefficient was determined in conditions of a test gas pressure of 15 N/cm², a test temperature of 25° C. and a gas transmission area of 15.2 cm².

TABLE 7

| | | | | | | | Results of performance evaluation | | |
|---|---|---|---|---|---|---|---|---|---|
| | | | | | | | | | Oxygen |
| | | Polyvinyl alcohol | | | | | | | transmission |
| | | | Ethylene | Saponification | PVA | Polyvinyl acetal resin | Rate of change | Adhesion | coefficient (cc · |
| | | Polymerization | content | degree | blending | Aldehyde (acetalization | of ink viscosity | to | cm/cm² · |
| | | degree | (mole %) | (mole %) | ratio | degree: mole %) | (%) | substrate | sec · cmHg) |
| Example | 21 | 300 | 5 | 98 | — | n-butyl aldehyde (68) | 8 | ◯ | 1.1 |
| | 22 | 300 | 10 | 88 | — | n-butyl aldehyde (62) | 7 | ◯ | 1.4 |
| | 23 | 800 | 5 | 95 | — | n-butyl aldehyde (32) | 10 | ◯ | 1.5 |
| | | | | | | Acetaldehyde (34) | | | |
| | 24 | 600 | 10 | 88 | — | Acetaldehyde (65) | 6 | ◯ | 1.3 |
| | 25 | 300 | 5 | 93 | 1/1 | n-butyl aldehyde (68) | 8 | ◯ | 1.2 |
| | | 300 | 0 | 98 | Weight ratio | | | | |
| | 26 | 600 | 5 | 93 | 1/1 | n-butyl aldehyde (30) | 5 | ◯ | 1.1 |
| | | 600 | 0 | 98 | Weight ratio | Acetaldehyde (36) | | | |
| | 27 | 800 | 5 | 93 | 1/1 | Acetaldehyde (70) | 6 | ◯ | 1.1 |
| | | 800 | 0 | 98 | Weight ratio | | | | |
| Comparative | 18 | 300 | 0 | 98 | — | n-butyl aldehyde (68) | 38 | X | 8.5 |
| Example | 19 | 300 | 0 | 88 | — | n-butyl aldehyde (62) | 42 | X | 8.7 |
| | 20 | 800 | 0 | 93 | — | n-butyl aldehyde (32) | 36 | X | 9.2 |
| | | | | | | Acetaldehyde (34) | | | |
| | 21 | 600 | 0 | 88 | — | Acetaldehyde (65) | 48 | X | 8.3 |
| | 22 | 300 | 0 | 93 | 1/1 | n-butyl aldehyde (68) | 37 | X | 9.7 |
| | | 300 | 0 | 98 | Weight ratio | | | | |
| | 23 | 600 | 0 | 93 | 1/1 | n-butyl aldehyde (30) | 40 | X | 8.9 |
| | | 600 | 0 | 98 | Weight ratio | Acetaldehyde (36) | | | |
| | 24 | 800 | 0 | 93 | 1/1 | Acetaldehyde (70) | 39 | X | 9.1 |
| | | 800 | 0 | 98 | Weight ratio | | | | |

The results of Table 7 show that the inks obtained in Examples 21 to 27 were significantly low in the secular change of viscosity and the oxygen transmission coefficient of inks and significantly high in the adhesion to a substrate compared with the inks obtained in Comparative Examples 18 to 24.

### EXAMPLE 28

<Preparation of Modified Polyvinyl Acetal Resin>

193 g of modified polyvinyl alcohol, which has a polymerization degree of 500, an ethylene content of 5 mole % and a saponification degree of 98 mole %, having ethylene in a random basis as a constituent unit of a main chain was added to 2,900 g of distilled water and the mixture was stirred at a temperature of 90° C. for about 2 hours and dissolved. This solution was cooled to 28° C. and 20 g of 35 weight % hydrochloric acid and 125 g of n-butyl aldehyde were added to the solution and a temperature of the mixture was lowered to 20° C. and kept at this temperature to acetalize it and precipitate a reaction product. Then, a liquid temperature was kept at 30° C. for 5 hours to complete an acetalization reaction. The mixture of a reaction product was washed with distilled water and sodium hydrogencarbonate was added to the washed modified polyvinyl acetal resin dispersion to adjust the solution to a pH of 8. Next, the solution was kept at 60° C. for 5 hours, and then cooled and washed with distilled water a hundred times as much as a solid matter. Further, after the solution was kept at 50° C. for 5 hours, it was washed with distilled water a hundred times as much as a solid matter, dehydrated and then dried.

The resulting modified polyvinyl acetal resin was dissolved in DMSO-d₆ and a degree of acetalization was measured using ¹³C-NMR spectrometer to obtain the acetalization degree of 75 mole %. And, the amounts of remaining aldehyde and remaining water were 10 ppm and 2.0 weight %, respectively. It could be verified that the modified polyvinyl acetal resin had ethylene in a random basis as a constituent unit of a main chain because only one glass transition temperature appeared when the glass transition temperature of the resulting polyvinyl acetal resin was measured with a differential scanning calorimeter and the modified polyvinyl acetal resin was dissolved thoroughly in a mixed solution of ethanol and toluene having a weight ratio of 1:1 and in methyl ethyl ketone. Incidentally, the above-mentioned amount of remaining aldehyde was measured by thermally extracting the modified polyvinyl acetal resin in a heating furnace and measuring an extract using a gas chromatography. The above-mentioned amount of remaining water was measured using a Karl Fischer moisture meter.

<Preparation of Coating Solution for Thermal Developing Photosensitive Material Film>

5.0 g of the above-mentioned modified polyvinyl acetal resin, 5.0 g of silver behenate and 40 g of methyl ethyl ketone were mixed with a ball mill for 24 hours, and further 0.2 g of N-lauryl-1-hydroxy-2-naphthamide was added to the mixture and this mixture was again milled by the ball mill to obtain a coating solution.

<Preparation of Thermal Developing Photosensitive Material Film>

The above-mentioned coating solution was applied to a polyester substrate so as to be 10 μm in thickness after drying and dried. A solution consisting of 0.5 g of lead N,N-dimethyl-p-phenylenediamine sulfate, 2 g of polyvinylpyrrolidone and 30 ml of methanol was applied to this coated surface so as to be 1 μm in thickness after drying and dried. A thermal developing photosensitive material film was prepared by laminating thus.

### EXAMPLES 29 TO 34, COMPARATIVE EXAMPLES 25 TO 28

Thermal developing photosensitive material films were prepared by following the same procedure as Example 28 except for changing a polymerization degree, a saponification degree, a kind of aldehyde, an acetalization degree, an amount of remaining water and an amount of remaining aldehyde of modified polyvinyl alcohol as shown in Table 8. It could be verified that the modified polyvinyl acetal resins, obtained in Examples 29 to 34, had ethylene in a random basis as a constituent unit of a main chain because only one glass transition temperature, which corresponded to one kind of modified polyvinyl acetal contained, appeared when the glass transition temperature of modified polyvinyl acetal resin was measured with a differential scanning calorimeter and the modified polyvinyl acetal resin was dissolved thoroughly in a mixed solution of ethanol and toluene having a weight ratio of 1:1 and in methyl ethyl ketone.

<Performance Evaluations>

Performances of the thermal developing photosensitive material films obtained in Examples 28 to 34 and Comparative Examples 25 to 28 were evaluated according to the following methods. The results of evaluations were shown in Table 8.

(Storage Stability of Raw Film)

The thermal developing photosensitive material film was stored in conditions of 20° C. and 90% humidity for 1 month. Then, the photosensitive film was exposed through a tone pattern film to light from a high-voltage mercury lamp of 250 W at a distance of 20 cm for 0.3 second and heated for 3 seconds with a hot plate of 110° C. to obtain a pattern image having a cyan color. The resulting film was rated on the following scale of 3 levels.

◯: there was no fog and sharpness was good

Δ: there were a few fogs and sharpness was not so good.

X: there were many fogs and sharpness was poor.

(Blocking Property of Raw Film)

The thermal developing photosensitive material film was cut in sheets of a A4-size, and each sheet was superposed on another up to 100 sheets and stored in conditions of 40° C. and 90% humidity for 1 month. The level of blocking of the films in that time was rated on the following scale of 3 levels.

◯: there was no blocking and each sheet was released neatly.

Δ: blocking occurred in a part of film sheets and some parts were difficult to be released.

X: blocking occurred in most of film sheets and it was considerably difficult to release them.

(Storage Stability of Film After Forming Image)

The photosensitive film was exposed through a tone pattern film to light from a high-voltage mercury lamp of 250 W at a distance of 20 cm for 0.3 second and then heated for 3 seconds with a hot plate of 110° C. to obtain a pattern image having a cyan color. Then, the film was stored in conditions of 40° C. and 90% humidity for 1 month. The surface condition of the film in that time was rated on the following scale of 3 levels.

◯: the image which had been formed before storage was retained.

Δ: a part of the image changed and became white after storage.

X: appreciable part of the image changed and became white after storage.

TABLE 8

| | | Polyvinyl alcohol | | | | | | | | | |
|---|---|---|---|---|---|---|---|---|---|---|---|
| | | | | Saponi- | | Polyvinyl acetal resin | | | Results of performance evaluation | | |
| | | Po- | | fication | | | | Amount | Storage | Blocking | Storage |
| | | lymeri- | Ethylene | degree | PVA | Aldehyde | Amount of | of water | stability | property | stability of film |
| | | zation | content | (mole | blending | (acetalization | aldehyde | content | of | of | after forming |
| | | degree | (mole %) | %) | ratio | degree: mole %) | (ppm) | (%) | raw film | raw film | image |
| Example | 28 | 500 | 5 | 98 | — | n-butyl aldehyde(75) | 10 | 2.0 | ◯ | ◯ | ◯ |
| | 29 | 800 | 10 | 95 | — | n-butyl aldehyde(72) | 25 | 1.5 | ◯ | ◯ | ◯ |
| | 30 | 800 | 5 | 88 | — | n-butyl aldehyde(66) | 10 | 2.0 | ◯ | ◯ | ◯ |
| | 31 | 500 | 10 | 98 | — | n-butyl aldehyde(34) | 5 | 1.5 | ◯ | ◯ | ◯ |
| | | | | | | Acetaldehyde(37) | | | | | |
| | 32 | 800 | 5 | 88 | 1/1 | n-butyl aldehyde(63) | 8 | 1.5 | ◯ | ◯ | ◯ |
| | | 800 | 0 | 88 | Weight ratio | | | | | | |
| | 33 | 500 | 5 | 98 | 1/1 | Acetaldehyde(73) | 3 | 2.0 | ◯ | ◯ | ◯ |
| | | 800 | 0 | 98 | Weight ratio | | | | | | |
| | 34 | 500 | 5 | 98 | 1/1 | n-butyl aldehyde(30) | 3 | 1.5 | ◯ | ◯ | ◯ |
| | | 800 | 0 | 88 | Weight ratio | Acetaldehyde(36) | | | | | |
| Comparative | 25 | 500 | 0 | 98 | — | n-butyl aldehyde(60) | 3 | 3.5 | X | X | X |
| Example | 26 | 800 | 0 | 98 | — | Acetaldehyde(62) | 3 | 5.0 | X | X | X |
| | 27 | 500 | 0 | 98 | — | n-butyl aldehyde(25) | 3 | 6.5 | X | X | X |
| | | | | | | Acetaldehyde(30) | | | | | |
| | 28 | 500 | 0 | 98 | 1/1 | n-butyl aldehyde(58) | 3 | 4.5 | X | X | X |
| | | 800 | | 98 | Weight ratio | | | | | | |

The results of Table 8 show that the thermal developing photosensitive material films obtained in Examples 28 to 34 were superior in the storage stability of a raw film, the blocking property of a raw film and the storage stability of film after forming images compared with the thermal developing photosensitive material films obtained in Comparative Examples 25 to 28.

### EXAMPLE 35

<Preparation of Modified Polyvinyl Acetal Resin>

193 g of modified polyvinyl alcohol, which has a polymerization degree of 800, an ethylene content of 5 mole % and a saponification degree of 93 mole %, having ethylene in a random basis as a constituent unit of a main chain was added to 2,900 g of pure water and the mixture was stirred at a temperature of 90° C. for about 2 hours and dissolved. This solution was cooled to 28° C. and 20 g of 35 weight % hydrochloric acid and 115 g of n-butyl aldehyde were added to the solution and a temperature of the mixture was lowered to 20° C. and kept at this temperature to acetalize it and precipitate a reaction product. Then, a liquid temperature was kept at 30° C. for 5 hours to complete an acetalization reaction. The mixture of a reaction product was neutralized, water-washed and dried by a normal method to obtain white powder of a modified polyvinyl acetal resin having ethylene in a random basis as a constituent unit of a main chain.

The resulting modified polyvinyl acetal resin was dissolved in DMSO-d₆ and a degree of acetalization was measured using ¹³C-NMR spectrometer to obtain the acetalization degree of 68 mole %. And, it could be verified that the modified polyvinyl acetal resin had ethylene in a random basis as a constituent unit of a main chain because only one glass transition temperature appeared when the glass transition temperature was measured with a differential scanning calorimeter and the modified polyvinyl acetal resin was dissolved thoroughly in a mixed solution of ethanol and toluene having a weight ratio of 1:1 and in methyl ethyl ketone.

<Preparation of a Slurry Composition for a Ceramic Green Sheet>

10 parts by weight of the above-mentioned modified polyvinyl acetal resin was added to a mixed solvent of 30 parts by weight of toluene and 15 parts by weight of ethanol, stirred and dissolved. To this resin solution, 3 parts by weight of dibutyl phthalate was added as a plasticizer, stirred and dissolved. 100 parts by weight of barium titanate powder, having a mean particle diameter of 0.3 μm, was added to the resin solution thus obtained as ceramic powder. This mixture was mixed for 36 hours with a ball mill and a slurry composition for a ceramic green sheet, in which the barium titanate powder was dispersed, was obtained.

<Preparation of Ceramic Green Sheet>

The above-mentioned slurry composition for a ceramic green sheet was applied to the polyester film, which had been treated for releasing, in a thickness of 6 μm and dried with winds at room temperature for 30 minutes and further dried at 60 to 80° C. for 15 hours with a hot air dryer to dry an organic solvent and a ceramic green sheet of a thin layer having a thickness of 3 μm was obtained.

### EXAMPLES 36 TO 41

By following the same procedure as Example 34 except for changing a polymerization degree, an ethylene content, a saponification degree, a kind of aldehyde, an acetalization degree, a mean particle diameter of ceramic powder and a plasticizer of polyvinyl alcohol as shown in Table 9, modified polyvinyl acetal resins, having ethylene in a random basis as a constituent unit of a main chain, were prepared, and slurry compositions and ceramic green sheets were prepared. In addition, in Examples 39 to 41, a mixture of modified polyvinyl alcohol and unmodified polyvinyl alcohol having a weight ratio of 1:1 was used in preparation of the modified polyvinyl acetal resin. It could be verified that the modified polyvinyl acetal resins, obtained in Examples 36 to 41, had ethylene in a random basis as a constituent unit of a main chain because only one glass transition temperature, which corresponded to one kind of modified polyvinyl acetal contained, appeared when the glass transition temperature of modified polyvinyl acetal resin was measured with a differential scanning calorimeter and the modified polyvinyl acetal resin was dissolved thoroughly in a mixed solution of ethanol and toluene having a weight ratio of 1:1 and in methyl ethyl ketone.

### COMPARATIVE EXAMPLES 29 TO 35

By following the same procedures as corresponding Examples 35 to 41 except for using unmodified polyvinyl alcohol having the same structure as modified polyvinyl alcohol used in Examples 35 to 41 other than not containing ethylene as a monomer unit, polyvinyl acetal resins having the same acetalization degree as corresponding Examples 35 to 41 were prepared and slurry compositions and ceramic green sheets were prepared using these polyvinyl acetal resins.

<Performance Evaluations>

The viscosity and the viscosity stability of the slurry compositions, and the releasability, the adhesive property and the ductility of the ceramic green sheets, which were obtained in Examples 35 to 41 and Comparative Examples 29 to 35, were evaluated according to the following methods and the results of evaluations were shown in Tables 9 and 10. The moisture absorption of the ceramic green sheets and the amounts of the thermal decomposition residue after sintering of the ceramic green sheets, which were obtained in Examples 35 to 41 and Comparative Examples 29 to 35, were evaluated according to the following methods and the results were shown in Tables 11.

(Viscosity of Slurry Composition and Difference in Viscosity)

The viscosities of the slurry compositions obtained in Examples 35 to 41 and Comparative Examples 29 to 35 were measured at 20° C. using a Brookfield type rotational viscometer and these viscosities were taken as initial viscosities.

Next, the viscosity of the slurry composition obtained in Example 35 was compared with the viscosity of the slurry composition obtained in Comparative Example 29 corresponding to Example 35, and (a rate of) a difference in viscosity was determined from the following formula (6).

Difference in viscosity (%)=(G−H)/H×100 (6)

In the formula (6), G represents the viscosity of the slurry composition (Example 35) made from the modified polyvinyl acetal resin and H represents the viscosity of the slurry composition (Comparative Example 29) made from the unmodified polyvinyl acetal resin.

Similarly, the viscosities of the slurry compositions obtained in Examples 36 to 41 were compared with the viscosities of the slurry compositions obtained in Comparative Examples 30 to 35 corresponding to Examples 36 to 41, respectively, and a difference in viscosity was determined.

(Secular Stability of Slurry Viscosity (Rate of Change of Viscosity))

The slurry solution of which the above-mentioned initial viscosity was measured was stored for 1 month in a thermostatic chamber kept at 20° C., and the viscosity after the storage was measured at 20° C. using a Brookfield type rotational viscometer, and a rate of change of viscosity was determined from the following formula (7).

Rate of change of viscosity (%)=(I−J)/J×100 (7)

In the formula (7), I represents the viscosity of 1 month later and J represents the initial viscosity.

(Releasability of a Ceramic Green Sheet)

Each of the ceramic green sheets obtained in Examples 35 to 41 and Comparative Examples 29 to 35 was cut in sheets of a size of 10 cm×10 cm, and each sheet was superposed on another up to 10 sheets on a PET film and laminated under conditions of being thermally attached to another by pressure of 1,500 N/cm² at 70° C. for 10 minutes, and then the state in releasing the ceramic green sheets from the PET film was rated on the following scale of 3 levels through a sensory analysis based on visual observations.

◯: there was no ceramic green sheet adhered to the PET film and there was no break nor crack of the ceramic green sheet.

Δ: there was a part of ceramic green sheets adhered to the PET film and there were breaks and cracks of the ceramic green sheet in part.

X: there were many parts of ceramic green sheets adhered to the PET film and there were many breaks and cracks of the ceramic green sheet.

(Adhesive Property of a Ceramic Green Sheet)

Each of the ceramic green sheets obtained in Examples 35 to 41 and Comparative Examples 29 to 35 was cut in sheets of a size of 10 cm×10 cm, and each sheet was superposed on another up to 200 sheets and laminated under conditions of being thermally attached to another by pressure of 1,500 N/cm² at 70° C. for 10 minutes, and then the adhesive property between the respective ceramic green sheet layers was rated on the following scale of 3 levels through a sensory analysis based on visual observations.

◯: there was no delamination and the respective ceramic green sheet layers adhered to one another.

Δ: there were delaminations in part.

X: there were considerable delaminations

(Ductility of a Sheet and Difference in Ductility)

The ceramic green sheets obtained in Examples 35 to 41 and Comparative Examples 29 to 35 were stretched at a stretch speed of 10 mm/minute at 20° C. and a ductility of a maximum point was measured using Autograph (manufactured by SHIMADZU CORPORATION).

Next, the ductility of a maximum point of the ceramic green sheet obtained in Example 35 was compared with the ductility of a maximum point of the ceramic green sheet obtained in Comparative Example 29 corresponding to Example 35, and (a rate of) a difference in ductility was determined from the following formula (8).

Difference in ductility (%)=(K−L)/F×100 (8)

In the formula (8), K represents the ductility of a maximum point of the ceramic green sheet (Example 35) made from the modified polyvinyl acetal resin and L represents the ductility of a maximum point of the ceramic green sheet (Comparative Example 29) made from the unmodified polyvinyl acetal resin.

Similarly, the ductilities of a maximum point of the ceramic green sheets obtained in Examples 36 to 41 were compared with the ductilities of a maximum point of the ceramic green sheet obtained in Comparative Examples 30 to 35 corresponding to Examples 36 to 41, respectively, and (a rate of) a difference in ductility was determined.

TABLE 9

| | | Polyvinyl alcohol | | | | Polyvinyl | Ceramic | | Results of performance evaluation | | | | |
|---|---|---|---|---|---|---|---|---|---|---|---|---|---|
| | | | | Sa- | | acetal resin | Kind | | Slurry | | Ceramic green sheet | | |
| | | Po- | | ponifi- | | Aldehyde | (mean | | Difference | Rate of | Re- | | Differ- |
| | | lymeri- | Ethylene | cation | PVA | (acetalization | particle | | in | change of | leas- | Ad- | ence in |
| | | zation | content | degree | blending | degree: | diameter; | Plasticizer | viscosity | viscosity | abili- | hesive | ductility |
| | | degree | (mole %) | (mole %) | ratio | mole %) | μm) | Kind | (%) | (%) | ty | property | (%) |
| Ex- | 35 | 800 | 5 | 93 | — | n-butyl | Barium | Dibutyl | −57 | +4 | ◯ | ◯ | +95 |
| ample | | | | | | aldehyde | titanate | phthalate | | | | | |
| | | | | | | (68) | (0.3) | | | | | | |
| | 36 | 800 | 10 | 88 | — | n-butyl | Barium | Dibutyl | −53 | +7 | ◯ | ◯ | +88 |
| | | | | | | aldehyde | titanate | phthalate | | | | | |
| | | | | | | (60) | (0.3) | | | | | | |
| | 37 | 800 | 5 | 93 | — | n-butyl | Barium | Dibutyl | −54 | +9 | ◯ | ◯ | +82 |
| | | | | | | aldehyde | titanate | octanol | | | | | |
| | | | | | | (28) | (0.3) | | | | | | |
| | | | | | | Acetaldehyde | | | | | | | |
| | | | | | | (34) | | | | | | | |
| | 38 | 1700 | 10 | 88 | — | Acetaldehyde | Barium | Dibutyl | −56 | +11 | ◯ | ◯ | +73 |
| | | | | | | (65) | titanate | octanol | | | | | |
| | | | | | | | (0.3) | | | | | | |
| | 39 | 600 | 5 | 93 | 1/1 | n-butyl | Barium | Dibutyl | −59 | +6 | ◯ | ◯ | +85 |
| | | 600 | 0 | 98 | Weight | aldehyde | titanate | octanol | | | | | |
| | | | | | ratio | (68) | (0.3) | | | | | | |
| | 40 | 600 | 5 | 93 | 1/1 | n-butyl | Barium | Dibutyl | −55 | +8 | ◯ | ◯ | +78 |
| | | 600 | 0 | 98 | Weight | aldehyde | titanate | phthalate | | | | | |
| | | | | | ratio | (30) | (0.3) | | | | | | |
| | | | | | | Acetaldehyde | | | | | | | |
| | | | | | | (36) | | | | | | | |
| | 41 | 600 | 5 | 93 | 1/1 | Acetaldehyde | Barium | Dibutyl | −52 | +13 | ◯ | ◯ | +71 |
| | | 600 | 0 | 98 | Weight | (70) | titanate | phthalate | | | | | |
| | | | | | ratio | | (0.3) | | | | | | |

TABLE 10

| | | Polyvinyl alcohol | | | | | Ceramic | | Results of performance evaluation | | |
|---|---|---|---|---|---|---|---|---|---|---|---|
| | | | | Sa- | | | Kind | | Slurry | | |
| | | Po- | | ponifi- | | | (mean | | Rate of | | |
| | | lymeri- | Ethylene | cation | PVA | Polyvinyl acetal resin | particle | | change of | Ceramic green sheet | |
| | | zation | content | degree | blending | Aldehyde (acetalization | diameter; | Plasticizer | viscosity | | Adhesive |
| | | degree | (mole %) | (mole %) | ratio | degree: mole %) | μm) | Kind | (%) | Releasability | property |
| Com- | 29 | 800 | 0 | 93 | — | n-butyl aldehyde(68) | Barium | Dibutyl | +40 | ◯ | Δ |
| parative | | | | | | | titanate | phthalate | | | |
| Example | | | | | | | (0.3) | | | | |
| | 30 | 800 | 0 | 88 | — | n-butyl aldehyde(60) | Barium | Dibutyl | +53 | ◯ | Δ |
| | | | | | | | titanate | phthalate | | | |
| | | | | | | | (0.3) | | | | |
| | 31 | 800 | 0 | 93 | — | n-butyl aldehyde(28) | Barium | Dibutyl | +68 | Δ | X |
| | | | | | | Acetaldehyde(34) | titanate | octanol | | | |
| | | | | | | | (0.3) | | | | |
| | 32 | 1700 | 0 | 88 | — | Acetaldehyde(65) | Barium | Dibutyl | +82 | Δ | X |
| | | | | | | | titanate | octanol | | | |
| | | | | | | | (0.3) | | | | |
| | 33 | 600 | 0 | 93 | 1/1 | n-butyl aldehyde(68) | Barium | Dibutyl | +44 | ◯ | Δ |
| | | 600 | | 98 | Weight | | titanate | octanol | | | |
| | | | | | ratio | | (0.3) | | | | |
| | 34 | 600 | 0 | 93 | 1/1 | n-butyl aldehyde(30) | Barium | Dibutyl | +72 | Δ | X |
| | | 600 | | 98 | Weight | Acetaldehyde(36) | titanate | phthalate | | | |
| | | | | | ratio | | (0.3) | | | | |
| | 35 | 600 | 0 | 93 | 1/1 | Acetaldehyde(70) | Barium | Dibutyl | +93 | Δ | X |
| | | 600 | | 98 | Weight | | titanate | phthalate | | | |
| | | | | | ratio | | (0.3) | | | | |

The results of Tables 9 and 10 show that the slurry compositions obtained in Examples 35 to 41 were significantly low in the slurry viscosity and very stable in the secular stability of the slurry viscosity compared with the ceramic green sheets obtained in Comparative Examples 29 to 35.

And, the ceramic green sheets obtained in Examples 35 to 41 were excellent in the releasability and the adhesive property. On the other hand, the ceramic green sheets obtained in Comparative Examples 31, 32, 34 and 35 were hard and developed cracks in being released, and were found to delaminate in fair parts between sheet layers.

Also, the ceramic green sheets obtained in Examples 35 to 41 stretch well and were excellent in the flexibility compared with the ceramic green sheets obtained in Comparative Examples 29 to 35.

(Moisture Absorption of Green Sheet)

The ceramic green sheets obtained in Examples 35 to 41 and Comparative Examples 29 to 35 were cut in sheets of a size of 10 cm×10 cm, and these sheets were left alone in conditions of 20° C. and 90% humidity for 5 days and weighed before and after the duration of being left alone. The moisture absorption of a green sheet was determined from a change in weight during the duration of being left alone using the following formula (9).

Moisture absorption (%)=(M−N)/N×100 (9)

In the formula (9), M represents the weight of the ceramic green sheet after the duration of being left alone and N represents the weight of the ceramic green sheet measured before the duration.

(Thermal Decomposition Residue of Modified Polyvinyl Acetal Resin)

10 mg of the modified polyvinyl acetal resins obtained in Examples 35 to 41 and Comparative Examples 29 to 35 was heated at a rate of a temperature rise of 10° C./minute from room temperature to 700° C. in a nitrogen atmosphere, and then an amount of thermal decomposition residue was determined.

(Thermal Decomposition Residue of Ceramic Green Sheet)

Each of the ceramic green sheets obtained in Examples 35 to 41 and Comparative Examples 29 to 35 was cut in sheets of a size of 10 cm×10 cm, and each sheet was superposed on another up to 500 sheets and laminated under conditions of being thermally attached to another by pressure of 1,500 N/cm² at 70° C. for 10 minutes to obtain a laminate of a ceramic green sheet. Next, this ceramic green sheet laminate was heated at a rate of a temperature rise of 3° C./minute to 450° C. in a nitrogen atmosphere and kept at this temperature for 5 hours, and then heated at a rate of a temperature rise of 5° C./minute to 1,350° C. and kept at this temperature for 10 hours to sinter the ceramic completely. This sintered ceramic green sheet was cooled to room temperature and then the ceramic green sheet was divided into two halves and the state of the face of the divided ceramic green sheet, which was just located near the 250th layer, was observed with an electron microscope and rated on the following scale of 3 levels.

◯: the sheet was sintered uniformly and there was nothing other than ceramic powder.

Δ: black spot was rarely found in part in the ceramic green sheet.

X: fairly many black spots were found in the ceramic green sheet.

TABLE 11

| | | Polyvinyl alcohol | | | | | Ceramic | | | | |
|---|---|---|---|---|---|---|---|---|---|---|---|
| | | | | Sa- | | | Kind | | Results of performance evaluation | | |
| | | | | ponifi- | | | (mean | | Moisture | | Thermal |
| | | Po- | | cation | | Polyvinyl acetal resin | particle | | absorption | Thermal | decomposition |
| | | lymeri- | Ethylene | degree | PVA | Aldehyde | diam- | | of ceramic | decomposition | residue of |
| | | zation | content | (mole | blending | (acetalization | eter; | Plasticizer | green | residue of | ceramic green |
| | | degree | (mole %) | %) | ratio | degree: mole %) | μm) | Kind | sheet (%) | resin (%) | sheet |
| Ex- | 35 | 800 | 5 | 93 | — | n-butyl aldehyde(68) | | | 0.18 | 0.1 | ◯ |
| ample | 36 | 800 | 10 | 88 | — | n-butyl aldehyde(60) | Barium | Dibutyl | 0.22 | 0.05 | ◯ |
| | | | | | | | titanate | phthalate | | | |
| | | | | | | | (0.3) | | | | |
| | 37 | 800 | 5 | 93 | — | n-butyl aldehyde(28) | Barium | Dibutyl | 0.25 | 0.08 | ◯ |
| | | | | | | Acetaldehyde(34) | titanate | octanol | | | |
| | | | | | | | (0.3) | | | | |
| | 38 | 1700 | 10 | 88 | — | Acetaldehyde(65) | Barium | Dibutyl | 0.28 | 0.03 | ◯ |
| | | | | | | | titanate | octanol | | | |
| | | | | | | | (0.3) | | | | |
| | 39 | 600 | 5 | 93 | 1/1 | n-butyl aldehyde(68) | Barium | Dibutyl | 0.17 | 0.1 | ◯ |
| | | 600 | 0 | 98 | Weight ratio | | titanate | octanol | | | |
| | | | | | | | (0.3) | | | | |
| | 40 | 600 | 5 | 93 | 1/1 | n-butyl aldehyde(30) | Barium | Dibutyl | 0.24 | 0.1 | ◯ |
| | | 600 | 0 | 98 | Weight ratio | Acetaldehyde (36) | titanate | phthalate | | | |
| | | | | | | | (0.3) | | | | |
| | 41 | 600 | 5 | 93 | 1/1 | Acetaldehyde(70) | Barium | Dibutyl | 0.27 | 0.09 | ◯ |
| | | 600 | 0 | 98 | Weight ratio | | titanate | phthalate | | | |
| | | | | | | | (0.3) | | | | |
| Com- | 29 | 800 | 0 | 93 | — | n-butyl aldehyde(68) | Barium | Dibutyl | 0.43 | 2.8 | X |
| parative | | | | | | | titanate | phthalate | | | |
| Ex- | | | | | | (0.3) | | | | | |
| ample | 30 | 800 | 0 | 88 | — | n-butyl aldehyde(60) | Barium | Dibutyl | 0.45 | 2.7 | X |
| | | | | | | | titanate | phthalate | | | |
| | | | | | | | | (0.3) | | | |
| | 31 | 800 | 0 | 93 | — | n-butyl aldehyde(28) | Barium | Dibutyl | 0.47 | 2.4 | X |
| | | | | | | Acetaldehyde(34) | titanate | octanol | | | |
| | | | | | | | (0.3) | | | | |
| | 32 | 1700 | 0 | 88 | — | Acetaldehyde(65) | Barium | Dibutyl | 0.51 | 2.8 | X |
| | | | | | | | titanate | octanol | | | |
| | | | | | | | (0.3) | | | | |
| | 33 | 600 | 0 | 93 | 1/1 | n-butyl aldehyde(68) | Barium | Dibutyl | 0.44 | 2.4 | X |
| | | 600 | | 98 | Weight ratio | | titanate | octanol | | | |
| | | | | | | | (0.3) | | | | |
| | 34 | 600 | 0 | 93 | 1/1 | n-butyl aldehyde(30) | Barium | Dibutyl | 0.48 | 2.9 | X |
| | | 600 | | 98 | Weight ratio | Acetaldehyde(36) | titanate | phthalate | | | |
| | | | | | | | (0.3) | | | | |
| | 35 | 600 | 0 | 93 | 1/1 | Acetaldehyde(70) | Barium | Dibutyl | 0.52 | 2.6 | X |
| | | 600 | | 98 | Weight ratio | | titanate | phthalate | | | |
| | | | | | | | (0.3) | | | | |

The results of Table 11 show that the ceramic green sheets obtained in Examples 35 to 41 were significantly low in the moisture absorption, significantly less in the thermal decomposition residue of the modified polyvinyl acetal resin contained, and very less in the thermal decomposition residue of the ceramic green sheet itself and black carbon resulting from the thermal decomposition residue was not recognized in comparison with the ceramic green sheets obtained in Comparative Examples 29 to 35.

### INDUSTRIAL APPLICABILITY

According to the present invention, it is possible to provide the modified polyvinyl acetal resin, which is superior in flexibility, an adhesive property to a resin substrate under high humidities, heat resistance, a thermal decomposition property, humidity resistance and toughness and has low oxygen permeability and an adequate adhesive property and is low in viscosity and high in secular stability of viscosity in forming a solution thereof, and the adhesive composition, the ink, the coating material composition, the thermal developing photosensitive material, the slurry composition for a ceramic green sheet, and the ceramic green sheet, which use the modified polyvinyl acetal resin.

1. A modified polyvinyl acetal resin,
which is obtainable by acetalizing a modified polyvinyl alcohol having ethylene in a random basis as a constituent unit of a main chain and an ethylene content of 1 to 20 mole % and a saponification degree of 80 mole % or more and,
has ethylene in a random basis as a constituent unit of a main chain.

2. A modified polyvinyl acetal resin,
which is obtainable by acetalizing a mixture of polyvinyl alcohols containing at least a modified polyvinyl alcohol having ethylene in a random basis as a constituent unit of a main chain and an ethylene content of 1 to 20 mole % as a whole and a saponification degree of 80 mole % or more as a whole and,
has ethylene in a random basis as a constituent unit of a main chain.

3. The modified polyvinyl acetal resin according to claim 1,
wherein an acetalization degree is 40 to 80 mole %.

4. The modified polyvinyl acetal resin according to claim 1
which is one acetalized by butyl aldehyde and/or acetaldehyde.

5. The modified polyvinyl acetal resin according to claim 1
wherein a water content is 2.5 weight % or less.

6. The modified polyvinyl acetal resin according to claim 1,
wherein an amount of aldehyde is 100 ppm or less.

7. An ink,
which is obtainable by using the modified polyvinyl acetal resin according to claim 1.

8. A coating material,
which is obtainable by using the modified polyvinyl acetal resin according to claim 1.

9. An adhesive,
which comprises the modified polyvinyl acetal resin according to claim 1, and at least one thermosetting resin selected from the group consisting of a phenolic resin, an epoxy resin and a melamine resin.

10. A thermal developing photosensitive material,
which is obtainable by using the modified polyvinyl acetal resin according to claim 1.

11. A slurry composition for a ceramic green sheet,
which comprises the modified vinyl acetal resin according to claim 1, ceramic powder, a plasticizer and an organic solvent.

12. A ceramic green sheet,
which is obtainable by using the slurry composition for a ceramic green sheet according to claim 11.

13. The modified polyvinyl acetal resin according to claim 2,
wherein an acetalization degree is 40 to 80 mole %.

14. The modified polyvinyl acetal resin according to claim 2,
which is one acetalized by butyl aldehyde and/or acetaldehyde.

15. The modified polyvinyl acetal resin according to claim 3,
which is one acetalized by butyl aldehyde and/or acetaldehyde.

16. The modified polyvinyl acetal resin according to claim 2,
wherein a water content is 2.5 weight % or less.

17. The modified polyvinyl acetal resin according to claim 3,
wherein a water content is 2.5 weight % or less.

18. The modified polyvinyl acetal resin according to claim 4,
wherein a water content is 2.5 weight % or less.

19. The modified polyvinyl acetal resin according to claim 2,
wherein an amount of aldehyde is 100 ppm or less.

20. The modified polyvinyl acetal resin according to claim 3,
wherein an amount of aldehyde is 100 ppm or less.
